(19) United States
(12) Patent Application Publication
(10) Pub. No.: US 2026/0360033 A1
(43) Pub. Date: Nov. 12, 2026

(54) REFERENCE POINT NORMALIZATION IN IMAGES

(71) Applicant: Sorenson IP Holdings, LLC, Salt Lake City, UT (US)

(72) Inventor: Canlin Zhang, Fairfax, VA (US)

(21) Appl. No.: 19/200,331

(22) Filed: May 6, 2025

(51) Int. Cl. G06T 11/60; G06T 7/60

(52) U.S. Cl. CPC G06T 11/60; G06T 7/60; G06T 2207/30201

(57) ABSTRACT

A method of normalizing reference points in an image may include obtaining a set of reference points corresponding to an object in an image. The object in the image may have a first portion and a second portion. The method may further include modifying the set of reference points using a first normalization factor based on a first measurement of the first portion of the object using the set of reference points. After modifying the set of reference points, the method may also include determining a second measurement of the second portion of the object using the modified set of reference points. The method may further include modifying one or more modified reference points in the modified set of reference points which correspond to the second portion of the object using a second normalization factor based on the second measurement.

### FIELD

The embodiments discussed herein relate to reference point normalization in images.

### BACKGROUND

Traditional communication systems, such as standard and cellular telephone systems, enable verbal communications between people at different locations. Communication systems for hard-of-hearing individuals may also enable non-verbal communications instead of, or in addition to, verbal communications. Some communication systems for hard-of-hearing people enable communications between communication devices for hard-of-hearing people and communication systems for hearing users.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of at least one embodiment, a method of normalizing reference points in an image may include obtaining a set of reference points corresponding to an object in an image. In these and other embodiments, the object in the image may have a first portion and a second portion. The method may further include modifying the set of reference points using a first normalization factor based on a first measurement of the first portion of the object using the set of reference points. After modifying the set of reference points, the method may also include determining a second measurement of the second portion of the object using the modified set of reference points. The method may further include modifying one or more modified reference points in the modified set of reference points which correspond to the second portion of the object using a second normalization factor based on the second measurement.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example environment for sign language processing;

FIG. 2A illustrates a first frame from a first video depicting performance of a first signed word and a second frame from a second video depicting performance of a second signed word;

FIG. 2B illustrates a sequence of frames from a combined sign language video generated based on the first frame of FIG. 2A, a transition video, and the second frame of FIG. 2A.

FIG. 3 illustrates a flowchart of an example method of generating sign language;

FIG. 4 illustrates an operational workflow for interpolation of movement between a first set of reference points and a second set of reference points;

FIGS. 5A and 5B illustrate an example interpolation process used to generate a transition video;

FIG. 6 illustrates a flowchart of an example method of interpolation;

FIG. 7 illustrates an operational workflow for normalizing reference points in an image;

FIGS. 8A, 8B, and 8C illustrate an example implementation of the operational workflow of FIG. 7;

FIG. 9 illustrates a flowchart of an example method of normalizing reference points in an image; and

FIG. 10 illustrates an example system that may be used during sign language generation, interpolation of motion, and/or normalization of reference points in an image.

### DETAILED DESCRIPTION

Systems may be designed to allow persons with hearing or speech disabilities, such as those using sign language, to use video equipment to communicate with others via a typical voice telephone service, such as a phone call on a mobile device. As an example, these systems may be referred to as a video relay service (VRS). For example, in a video relay service, a deaf person may engage in a communication session with a hearing person. Video may be captured that includes sign language content generated by the deaf person and sent to an interpreter. The interpreter may interpret the sign language content and generate audio that includes an audio interpretation of the sign language content (e.g., spoken words). The audio may be sent to a hearing person. The hearing person may respond by generating audio that is sent to the interpreter. The interpreter may listen to the audio and generate sign language content that is captured in a video and provided back to the deaf person. In this manner, the deaf person may communicate via a phone call with a hearing person.

The use of an interpreter may involve the use of a third party to the communication session that may translate the sign language content into audio for the hearing person to understand and translate the audio from the hearing person into sign language for the deaf person to understand. Thus, in some instances, the ability of the deaf person and the hearing person to have a conversation via the VRS may be dependent on the availability of the interpreter. Consequently, the deaf person and the hearing person may have to wait until an interpreter is available to engage in a communication session. Furthermore, the deaf person and/or the hearing person may not be comfortable with a third person being present during their communication session.

Some embodiments in the present disclosure relate to systems and/or methods of sign language processing with respect to a VRS system or other systems. Sign language processing may include converting one form of language data to another form of language data. Language data may include data that represents or encodes human language. For example, language data may include text data, audio data, and/or sign language data (e.g., video depicting performance of sign language). More specifically, sign language processing may include sign language generation that includes generating sign language data from other forms of language data such as audio data or text data. Sign language processing may also include sign language recognition that includes converting sign language data to other forms of language data.

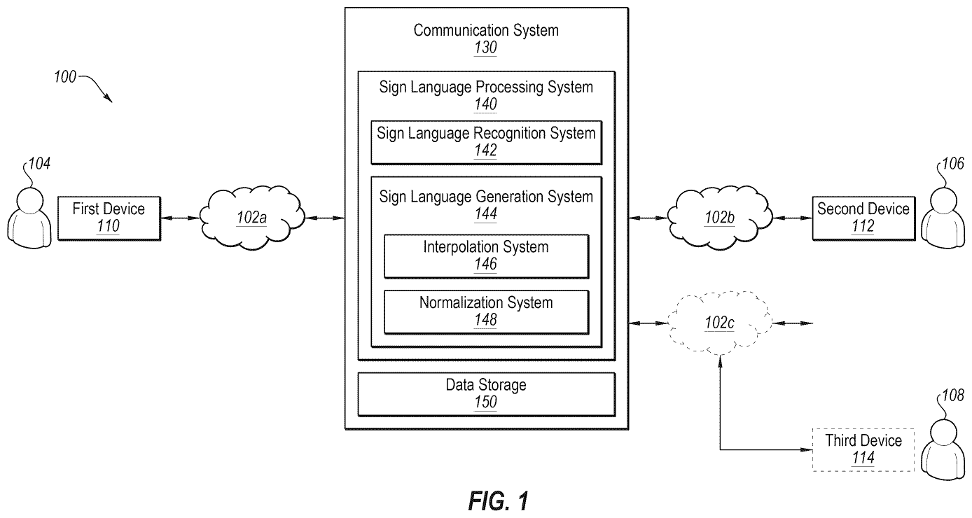

Thus, a sign language video may be generated based on audio and/or text received during a communication session based on the words spoken and/or written during a communication session. In some embodiments, a combined sign language video may be generated based on stored sign language videos depicting performance of signed words that correspond to the words spoken and/or written during the communication session and based on a transition video that may depict movement between the signed words depicted in the stored videos. As a result, in some instances, the interpreter may be omitted from the communication session and the deaf person and/or the hearing person may engage in a communication session with reduced delay and without the presence of a third person. While the above generation of sign language is described in the context of a VRS system, the generation of sign language described throughout this disclosure is not limited to VRS systems. The sign language generation is described in more detail with respect to FIGS. 1-3.

Some embodiments in the present disclosure may also relate to systems and/or methods of interpolation of motion of an object between a first position and a second position. More specifically, the interpolation of motion may be between a portion of a first signed word and a portion of a second signed word. For example, the interpolation of motion described throughout the disclosure may be utilized in sign language processing such as in the context of a VRS system or other systems to generate interpolated movement between signed words.

In the context of a VRS system, if sign language videos depicting performance of various signed words are provided to the deaf person individually, the translation of the audio provided by the hearing person may not be coherently conveyed to the deaf person based on the depiction of each signed word by itself. In some instances, the movement between signed words may provide useful context for the recipient of the sign language videos to determine the meaning of a sequence of signed words depicted in the sign language videos. In other words, providing a video of each signed word individually without providing the movement between the signed words may not fully and/or clearly convey the subject matter in the language data generated by the hearing person, and/or the depiction of the individual signed words may appear unnatural to the deaf person.

Interpolation of motion in a VRS system may allow an interpolated transition video depicting the movement between signed words in sign language videos to be generated, which may provide a more accurate translation of the language data generated by the hearing person. For example, interpolation between reference points from a first sign language video depicting performance of a first signed word and reference points from a second sign language video depicting performance of a second signed word may improve the ability of the VRS system to generate an interpolated transition video that more accurately depicts the movement between signed words depicted in sign language videos during a communication session. As a result, the movement between signed words that may be depicted by the generated interpolated video may provide a smooth transition between sign language videos such that a combined sign language video provided to the deaf person may be a comprehensible translation of the audio provided by the hearing person during the communication session. While the interpolation of motion is described in the context of a VRS system, the interpolation of motion described throughout this disclosure is not limited to VRS systems or generation of sign language. Interpolation between reference points is described in more detail with respect to FIGS. 1 and 4-6.

Some embodiments in the present disclosure may also relate to systems and/or methods for normalizing reference points in an image. Images may be captured and/or generated using different angles, field of views, perspectives, focal lengths, zoom levels, and/or other image parameters. In instances where these images are combined to generate, for example, a video, the generated video may include unnatural rendering artifacts such as scale mismatch (e.g., the subject suddenly appearing at a drastically different size), perspective distortion (e.g., loss of depth perception or depth exaggeration), and/or optical flow failure (e.g., inability to accurately render movement between frames).

Furthermore, reference points in images may correspond to different objects (e.g., different subjects such as a male subject and a female subject). In some instances, a video depicting a single object (e.g., a male subject) may be generated based on the reference points that may correspond to different objects (e.g., the male subject and a female subject). In instances where the reference points are unmodified, the object may appear to have a similar appearance throughout the video, but the size, shape, proportions, and/or dimensions of the object may change throughout the video because the object may be based upon the reference points of different objects. As a result, the object may appear to be inconsistently rendered throughout the generated video.

The normalization of reference points in an image described throughout the disclosure may be utilized in sign language processing such as in the context of a VRS system or other systems to generate combined sign language videos. In the context of a VRS system, normalizing reference points in an image (e.g., frames of videos depicting performance of signed words) may provide more accurate generation of sign language based on the language data received from the hearing person. For example, sign language videos depicting performance of signed words may be captured and/or generated utilizing different image parameters. For instance, a first sign language video depicting performance of a first signed word may have a first perspective such that the subject of the video appears close to the camera, and a second sign language video depicting performance of a second signed word may have a second perspective such that the subject of the video appears far away from the camera. As a result, scale mismatch and/or perspective distortion may occur if a combined sign language video is generated based on the sign language videos. The presence of rendering artifacts in the combined sign language video may be distracting to the deaf person, may render the combined sign language video less comprehensible or incomprehensible, and/or may inhibit the ability of the deaf person and the hearing person to engage in a communication session.

In another example, sign language videos depicting performance of signed words may be captured and/or generated using different subjects. For instance, the first sign language video may depict a first subject, and the second sign language video may depict a second subject. Where the generated combined sign language video depicts a single subject and is generated based on the first sign language video and the second sign language video, the subject may still be influenced by the size, shape, dimensions, and/or proportions of the first subject and/or the second subject. For example, the dimensions of the first subject and/or second subject may impact the depiction of the subject in different portions of the combined sign language video if reference points obtained from the first sign language video and/or the second sign language video are unmodified. As a result, the subject in the combined sign language video may appear to change in unnatural ways in the combined sign language video, which may render the combined sign language video less comprehensible or incomprehensible, and/or may inhibit the ability of the deaf person and the hearing person to engage in a communication session.

Normalization of reference points in images (e.g. frames) from the sign language videos may reduce the rendering artifacts and assist in generation of a combined sign language video that more accurately depicts the sign language corresponding to the language data generated by the hearing person. For example, reference points corresponding to the object in an image (e.g., from videos depicting performance of signed words) may be normalized. When a combined sign language video is generated based on sign language videos including normalized images, the combined sign language video may be more true to the audio provided by the hearing person, may be more comprehensible to the deaf person, and may facilitate the communication session between the deaf person and the hearing person. Additionally, the normalized images may enable a different subject to be depicted in the combined sign language video than the subjects in the sign language videos. While the normalization of reference points in an image is described in the context of a VRS system, the normalization of reference points in an image described throughout this disclosure is not limited to VRS systems or generation of sign language. Normalization of reference points is described in more detail with respect to FIGS. 1 and 7-9.

Turning to the figures, FIG. 1 illustrates an example environment 100 for sign language processing. The environment 100 may be arranged in accordance with at least one embodiment described in the present disclosure. The environment 100 may include a first network 102a; a second network 102b; a first device 110; a first user 104; a second device 112; a second user 106; and a communication system 130 that may include a sign language processing system 140, and a data storage 150. The sign language processing system 140 may include a sign language recognition system 142 and a sign language generation system 144. The sign language generation system 144 may include an interpolation system 146 and a normalization system 148. In some embodiments, the environment 100 may include a third network 102c; a third device 114; and a third user 108.

The first network 102a may be configured to communicatively couple the first device 110 and the communication system 130. The second network 102b may be configured to communicatively couple the second device 112 and the communication system 130. The third network 102c may be configured to communicatively couple the third device 114 and the communication system 130.

In some embodiments, the first network 102a, the second network 102b, and the third network 102c, referred to collectively as networks 102, may each include any network or configuration of networks configured to send and receive communications between devices and/or systems. In some embodiments, the networks 102 may each include a conventional type of network, a wired or wireless network, and may have numerous different configurations. Furthermore, the networks 102 may each include a local area network (LAN), a wide area network (WAN) (e.g., the Internet), or other interconnected data paths across which multiple devices and/or entities may communicate.

In some embodiments, the networks 102 may each include a peer-to-peer network. The networks 102 may also each be coupled to or may include portions of a telecommunications network for sending data in a variety of different communication protocols. In some embodiments, the networks 102 may each include Bluetooth® communication networks or cellular communication networks for sending and receiving communications and/or data. The networks 102 may also each include a mobile data network that may include fourth-generation (4G), fifth-generation (5G), long-term evolution (LTE), long-term evolution advanced (LTE-A), Voice-over-LTE (“VoLTE”) or any other mobile data network or combination of mobile data networks. Further, the networks 102 may each include one or more IEEE 802.11 wireless networks. In some embodiments, the networks 102 may be configured in a similar manner or a different manner. In some embodiments, the networks 102 may share various portions of one or more networks. For example, each of the networks 102 may include the Internet or some other network.

The first device 110, the second device 112, and/or the third device 114 may be any electronic or digital device. For example, the first device 110, the second device 112, and/or the third device 114 may include or may be included in a desktop computer, a laptop computer, a smartphone, a mobile phone, a tablet computer, a smart television, a wearable device such as smart glasses, or any other electronic device with a processor that is configured to enable user communication. In some embodiments, the first device 110, the second device 112, and/or the third device 114 may each include computer-readable-instructions stored on one or more computer-readable media that are configured to be executed by one or more processors to perform operations described in this disclosure.

In some embodiments, the second device 112 may be configured to obtain audio and broadcast audio. In some embodiments, the third device 114 may be configured to obtain audio and broadcast audio. As used in this disclosure, the term audio or audio data may be used generically to refer to sounds that may include spoken words. Furthermore, the term “audio” or “audio data” may be used generically to include audio in any format, such as a digital format, an analog format, or a propagating wave format. In these and other embodiments, the second device 112 and/or the third device 114 may be configured to provide obtained audio to the communication system 130. For example, the second device 112 may provide audio to the communication system 130 and data including a first word and a second word may be obtained from the audio.

As an example of obtaining audio, the second device 112 may be configured to obtain audio from the second user 106. For example, the second device 112 may obtain the audio from a microphone of the second device 112 or from another device that is communicatively coupled to the second device 112. The third device 114 may also be configured to obtain audio from the third user 108. As an example of broadcasting audio, the second device 112 may be configured to obtain audio from the communication system 130 and broadcast the audio via a speaker.

In some embodiments, the first device 110 may be configured to obtain video and present video. In some embodiments, the third device 114 may be configured to obtain video and present video. As used in this disclosure, the term video or video data may be used generically to refer to a sequence of images (e.g., frames). Furthermore, the term video or video data may be used generically to include video in any format, such as a digital format, an analog format, a compressed format, or any other format. In these and other embodiments, the first device 110 and/or the third device 114 may be configured to provide obtained video to the communication system 130.

As an example of obtaining video, the first device 110 may be configured to obtain a first video from the first user 104. For example, the first device 110 may obtain the first video from a camera of the first device 110 or from another device that is communicatively coupled to the first device 110. The third device 114 may also be configured to obtain video from the third user 108. As an example of presenting video, the third device 114 may be configured to obtain video from the communication system 130 and present the video via a display.

In some embodiments, the first device 110, the second device 112, and/or the third device 114 may be configured to obtain text and present text. In this disclosure, the term text may refer to a string of characters, including letters, numbers, and symbols of a spoken language that follows grammar and other conventions associated with the spoken language. Furthermore, the term text or text data may be used generically to refer to generally accepted written forms of a language that would be understood generally and would be akin to written text found in typical documents such as magazines, webpages, and books meant for the general public. In these and other embodiments, the first device 110, the second device 112, and/or the third device 114 may be configured to provide obtained text to the communication system 130.

As an example of obtaining text, the second device 112 may be configured to obtain text from the second user 106. For example, the second user 106 may input text into the second device 112 via a keyboard or another device that is communicatively coupled to the second device 112. As an example of presenting text, the first device 110 may be configured to obtain text from the communication system 130 and present the text via a display.

In some embodiments, each of the first device 110, the second device 112, and the third device 114 may be configured to establish communication sessions with other devices, such as the communication system 130. For example, each of the first device 110, the second device 112, and the third device 114 may be configured to establish an outgoing communication session, such as a telephone call, Voice over Internet Protocol (VOIP) call, video call, or conference call, among other types of outgoing communication sessions, with another device over the networks 102. In some embodiments, each of the first device 110, the second device 112, and the third device 114 may be configured to communicate, receive data from, and direct data to the communication system 130 during a communication session that involves the communication system 130.

In some embodiments, the first device 110 may be associated with the first user 104. The first device 110 may be associated with the first user 104 based on the first user 104 being the owner of the first device 110 and/or the first device 110 being controlled by the first user 104. For example, the first device 110 may be controlled by the first user 104 when the first device 110 is obtaining commands and input from the first user 104. In some embodiments, the first user 104 may be a sign language capable person. As used in this disclosure, the term “sign language capable person” is meant to encompass people who are deaf, people who are hard of hearing, anyone else using sign language for communication such as those who sign, understand sign language, or both. A person who communicates using sign language may be designated as a sign language capable person independent of their ability to hear or speak.

In some embodiments, the second device 112 may be associated with the second user 106. The second device 112 may be associated with the second user 106 based on the second user 106 being the owner of the second device 112 and/or the second device 112 being controlled by the second user 106. In some embodiments, the second user 106 may be a sign language capable person or a sign language incapable person. As used in this disclosure, the term “sign language incapable person” is meant to encompass people who cannot or choose not to communicate via sign language. A sign language incapable person may be designated as a sign language incapable person independent of their ability to sign if they choose not to sign.

In some embodiments, the third device 114 may be associated with the third user 108. The third device 114 may be associated with the third user 108 based on the third user 108 being the owner of the third device 114 and/or the third device 114 being controlled by the third user 108. In some embodiments, the third user 108 may be a sign language incapable person or a sign language capable person.

In some embodiments, the communication system 130 may include any configuration of hardware, such as processors, communication units, memory, servers, databases, and data storage 150 that are networked together and configured to perform one or more tasks. For example, the communication system 130 may include multiple computing systems, such as multiple servers that each include memory and at least one processor, which are networked together and configured to perform operations as described in this disclosure, among other operations. In some embodiments, the communication system 130 may include computer-readable-instructions on one or more computer-readable media, such as data storage 150 or databases, that are configured to be executed by one or more processors in the communication system 130 to perform operations described in this disclosure. Generally, the communication system 130 may be configured to establish and manage communication sessions between the first device 110, the second device 112, and/or the third device 114.

The communication system 130 may include the sign language processing system 140 and the data storage 150. The sign language processing system 140 may be a combination of hardware, such as processors, communication units, memory, servers, databases, and data storage (e.g. such as the data storage 150) that are networked together and configured to perform one or more tasks. The sign language processing system 140 may include the sign language recognition system 142 and/or the sign language generation system 144.

In some embodiments, the data storage 150 may store sign language videos that depict performance of signed words. As used in this disclosure, the term “sign language video” includes a video depicting performance of one or more signed words (e.g., a video including sign language data). As used in this disclosure, the term “signed word” includes a sign in sign language that represents one or more words in spoken or written language. For example, a sign language video may depict performance of a signed word in American Sign Language (ASL) or another sign language dialect.

For example, a sign language video may depict a subject such as a human (e.g., the third user 108) or a subject such as an avatar performing one or more signed words. In some embodiments, the avatar may be a 2-D or 3-D cartoon, a photorealistic avatar featuring the face of a user (e.g., the second user 106), an enhanced (better looking) version of the user, a figure designed by the user by specifying the hairstyle, clothing, eye color, and other features meant to represent the user, a character such as a wizard, a skeleton of a subject, the image of another person such as a celebrity, an image selected by the communication participant from a menu of options, a stick figure, an art deco or graphic art image, an animal, a plant, a character from a movie, or an inanimate object such as a stuffed animal or a toy.

In some embodiments, a sign language video may be associated with one or more words in the data storage 150. A sign language video may be associated with one or more words based on the sign language video including signs that represent the one or more words. In these and other embodiments, when the one or more words associated with a sign language video are obtained from language data received by the communication system 130, the sign language video associated with the one or more words may be selected from the data storage 150. For example, the data storage 150 may function as a searchable glossary such that when the word “Yes” is obtained from language data received by the communication system 130, the word “Yes” may be searched in the data storage 150, and a corresponding sign language video depicting performance of the signed word for “Yes” by a subject may be selected from the data storage 150. The term “searchable glossary” is meant to encompass a storage system by which the sign language videos are associated with words (e.g., written or spoken) that correspond to the signed words depicted in the sign language videos such that a successful search of a word in the glossary may provide a corresponding sign language video.

Additionally or alternately, a sign language video may be associated with a specific type of text called gloss. Gloss may be a label or a name for a sign. In ASL, a gloss is an English word that is used to name the ASL sign. The gloss does not necessarily relay the meaning of the signed word. Alternately or additionally, the gloss is not necessarily a transcription of the signed word and does not necessarily provide information as to how to create or recognize the signed word. In these and other embodiments, the data storage 150 may be searched for sign language videos corresponding to gloss obtained from language data received by the communication system 130.

In some embodiments, a sign language video may depict a subject performing a single signed word. For example, the data storage 150 may include a first sign language video depicting performance of a first signed word for “No” and a second sign language video depicting performance of a second signed word for “Thank you.” In some embodiments, a sign language video may depict a subject performing multiple signed words in sequence. For example, a sign language video may depict performance of the first signed word for “No,” and performance of the second signed word for “thank you” in sequence.

In some embodiments, sign language videos stored in the data storage 150 may depict different subjects performing different signed words. For example, a first sign language video may depict a male subject performing a first signed word, and a second sign language video may depict a female subject performing a second signed word. In some embodiments, sign language videos stored in the data storage 150 may depict different subjects performing the same signed words. For example, a first sign language video may depict an avatar performing a first signed word, a second sign language video may depict a male subject performing the first signed word, and/or a third sign language video may depict a female subject performing the first signed word.

In some embodiments, a searchable glossary of signed words may be stored in the data storage 150 for multiple subjects. For example, a searchable glossary of signed words may be stored in the data storage 150 for a female subject, a male subject, and/or an avatar (e.g., an animated cartoon). In these and other embodiments, the desired subject to perform the signed words may be selected based on input from the first user 104 and/or the second user 106. For example, the second device 112 may obtain language data including one or more words from the second user 106, and the second user 106 may provide input to the second device 112 to select an avatar to perform the signed words corresponding to the one or more words. In the foregoing example, the searchable glossary corresponding to the user selection may be activated in the data storage 150.

In some embodiments, a sign language video may be generated using a camera of a device. For example, a subject may perform a sign and a camera may generate video that captures the subject performing the sign. In these and other embodiments, the first device 110, the second device 112, the third device 114, or another device may generate a sign language video.

In some embodiments, the sign language generation system 144 may be configured to generate combined sign language videos. In some embodiments, a combined sign language video may be generated based on two or more sign language videos that are stored in the data storage 150. For instance, a first sign language video depicting performance of a first signed word and a second sign language video depicting performance of a second signed word may be used to generate a combined sign language video depicting performance of the first signed word and the second signed word. As used in this disclosure, the term “combined sign language video” is meant to encompass a video that may be generated based on multiple sign language videos to depict performance of multiple signed words and/or that may include multiple sign language videos that are stitched together, combined, joined, or otherwise combined into a single video depicting performance of multiple signed words.

In some embodiments, the data storage 150 may include transition videos. A “transition video” may include a video depicting movement between a first position of a first signed word depicted in a first sign language video and a second position of a second signed word depicted in a second sign language video.

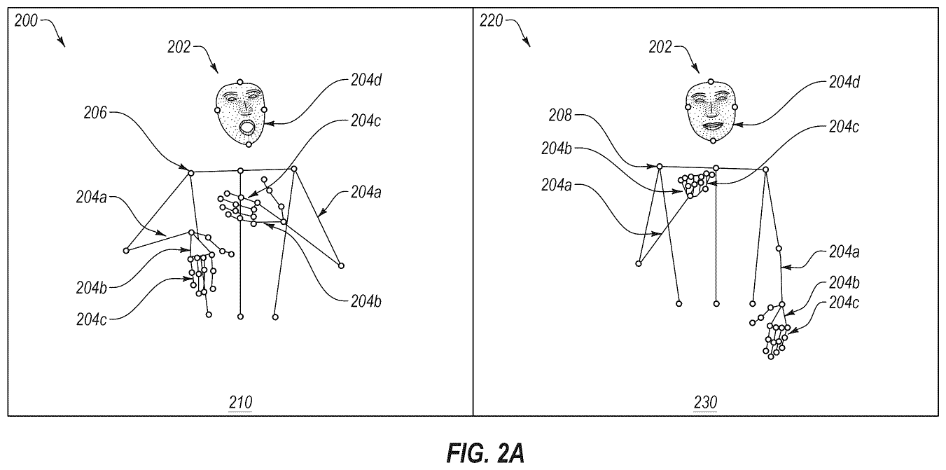

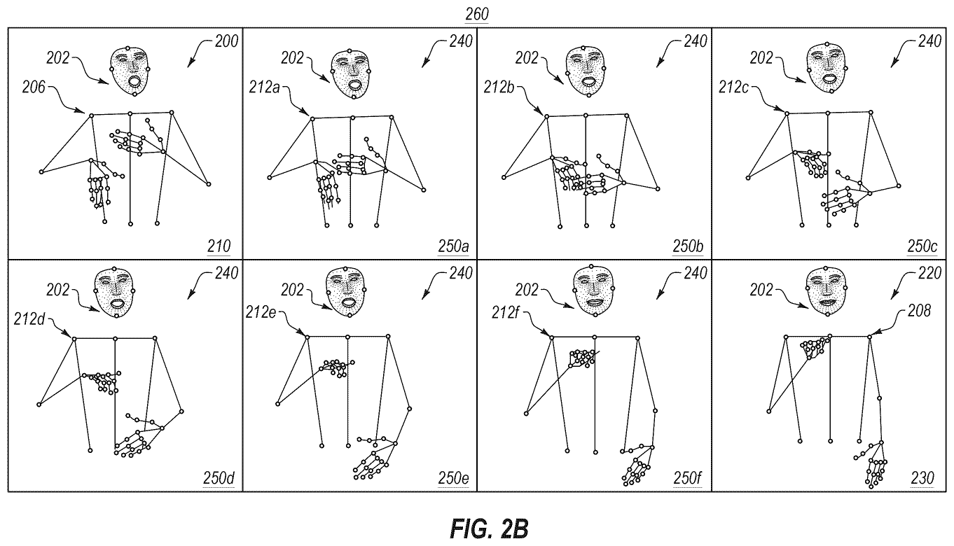

For example, FIG. 2A illustrates a first frame 210 of a first sign language video 200 depicting a subject 202 performing a first signed word and a second frame 230 of a second sign language video 220 depicting the subject 202 performing a second signed word. The first sign language video 200 and the second sign language video 220 may be stored in the data storage 150.

As illustrated in FIG. 2A, the subject 202 may be positioned differently in the first sign language video 200 and the second sign language video 220. Specifically, the subject 202 may be positioned differently at the end of the first sign language video 200 (e.g., the first frame 210), which may depict an ending position of the first signed word and at the beginning of the second sign language video 220 (e.g., the second frame 230), which may depict a beginning position of a second signed word. As illustrated in FIG. 2A, in the first frame 210, the right hand of the subject 202 is in an open position at the right side of the subject 202 with the fingers pointed downwards, and the left hand of the subject 202 is positioned across the body of the subject 202 in an open position with the palm facing the body of the subject 202. In the second frame 230, the right hand of the subject 202 is positioned in a fist in front of the body of the subject 202, and the left hand is positioned in an open position at the left side of the subject 202 with the fingers pointed downwards.

Continuing the example, the first sign language video 200 being combined with the second sign language video 220 without including a transition video may result in a rendering artifact where the hands skip directly from the ending position of the first sign language video 200 to the beginning position of the second sign language video 220. For instance, the right hand of the subject 202 may skip from being open and placed at side of the subject 202 in the first frame 210 to a fist in front of the body in the second frame 230, and the left hand of the subject 202 may skip from being in front of the body of the subject 202 in the first frame 210 to being at the left side of the subject 202 in the second frame 230. In these instances, the rendering artifacts that may result in the combined sign language video may be unnatural, distracting, and/or incomprehensible to the first user 104 when the combined sign language video is rendered on the first device 110.

In some embodiments, a transition video 240 illustrated in FIG. 2B may depict the movement between the first signed word in the first sign language video 200 and the second signed word in the second sign language video 220. As illustrated, in FIG. 2B, the transition video 240 may include transition frames 250a-250f, which may correspond to different positions of the subject 202 between the position of the subject 202 in the first sign language video 200 and the position of the subject 202 in the second sign language video 220. For example, the transition frames 250 illustrate the right hand moving from an open position at the right side of the subject 202 to a fist position in front of the body of the subject 202. Consequently, a combined sign language video 260 may be generated based on the transition video 240, the first sign language video 200, and the second sign language video 220 to depict performance of the first signed word, movement from the ending position of the first signed word to the beginning position of the second signed word, and performance of the second signed word. As a result, the transition video 240 may reduce rendering artifacts such that the combined sign language video 260 may be more natural and comprehensible when provided to the first user 104.

In some embodiments, transition videos may be stored in the data storage 150 for sign language videos that correspond to signed words that may frequently be used in sequence. For instance, the communication system 130 may store a transition video depicting movement between a first signed word corresponding to the word “No” and a second signed word corresponding to the words “thank you.” In some embodiments, a transition video may be stored for each possible combination of sign language videos stored in the data storage 150. For example, a transition video may be stored in the data storage 150 for each transition between a first sign language video depicting performance of a first signed word corresponding to the word “No” and every other sign language video stored in the data storage 150. Alternately or additionally, a transition video may be stored for some possible combinations of sign language videos stored in the data storage 150. For example, a transition video may be stored for the first 1000, 2000, 3000, 4000, 5000, or some other number of most likely possible combinations based on an analysis of typical usage in speech.

In some instances, the sign language videos and/or transition videos may be captured and/or generated with different image parameters. For example, a first sign language video corresponding to a first signed word, a transition video, and/or a second sign language video corresponding to a second signed word may be captured and/or generated using different angles, field of views, perspectives, focal lengths, zoom levels, and/or other image parameters. As discussed previously, when a combined sign language video is generated based on sign language videos with different image parameters, the differences in image parameters may result in rendering artifacts, which may be distracting to the first user 104 and/or may result in the combined sign language video being incomprehensible.

For example, as illustrated in FIG. 2A, the first sign language video 200 may have different image parameters than the second sign language video 220. In these and other instances, the subject 202 may appear to be, for example, at a different size, a different distance from the camera, and/or a different scale in the first sign language video 200 compared to the second sign language video 220 due to the different image parameters. The differences in image parameters may also carry over into the transition video 240. For example, the transition video 240 may appear to have similar image parameters to the first sign language video 200 at a first transition frame 250a of the transition video 240, and may appear to have similar image parameters to the second sign language video 220 at a sixth transition frame 250f of the transition video 240. As a result, the subject 202 may appear to change sizes, switch scales, and/or move further away from or closer to the camera when the combined sign language video 260 is provided to the first user 104.

In some instances, as mentioned previously, the sign language videos and/or transition videos may be captured and/or generated with different subjects. For example, the first sign language video may depict a first subject, and the second sign language video may depict a second subject. In some embodiments, the combined sign language video may be generated based on the first sign language video and the second sign language video, but may depict only the first subject, only the second subject, or some other subject (e.g., such as a subject selected based on user input).

For example, the first sign language video 200 illustrated in FIG. 2A may depict a different subject than the second sign language video 220. A first set of reference points 206 may be obtained from the first frame 210 of the first sign language video 200, and the first set of reference points 206 may correspond to a first subject. A second set of reference points 208 may be obtained from the second frame 230 of the second sign language video, and the second set of reference points 208 may correspond to a second subject. Generating the combined sign language video 260, which may only depict a single subject, using the first set of reference points 206 and the second set of reference points 208 without modification may impact how the subject is depicted in the combined sign language video 260. For example, at the beginning portion of the combined sign language video 260, which may be generated using the first set of reference points 206, the depiction of the subject may be impacted by the dimensions of the first subject in the first sign language video 200. Continuing the example, at the end portion of the combined sign language video 260, which may be generated using the second set of reference points 208, the depiction of the subject may be impacted by the dimensions of the second subject in the second sign language video 220. The differences in dimensions between the first subject and the second subject may also impact the transition video 240. For example, the transition video 240 may depict the subject having similar dimensions to the first subject in the first transition frame 250a and may appear to have similar dimensions to the second subject in the sixth transition frame 250f. As a result, the dimensions of the subject 202 may appear to change throughout the combined sign language video 260 when the combined sign language video 260 is provided to the first user 104.

Turning back to FIG. 1, in some embodiments, to reduce the rendering artifacts and/or to ensure a consistent depiction of the subject in the combined sign language video, the normalization system 148 may perform normalization operations on data included in one or more images of videos received, stored, and/or generated by the communication system 130. In some embodiments, the normalization system 148 may modify images included in sign language videos and/or transition videos. For instance, the normalization system 148 may modify the one or more images included in the transition videos and/or sign language videos such that the images appear to have the same or similar image parameters and/or appear to depict the same or similar subjects. In some embodiments, the normalization system 148 may modify the image parameters of the images and/or subjects of the images included in transition videos and/or sign language videos directly or indirectly. For example, the normalization system 148 may modify aspects of the image that result in or appear to result in a modification to the image parameters and/or subject despite the normalization system 148 not directly changing the image parameters and/or subject.

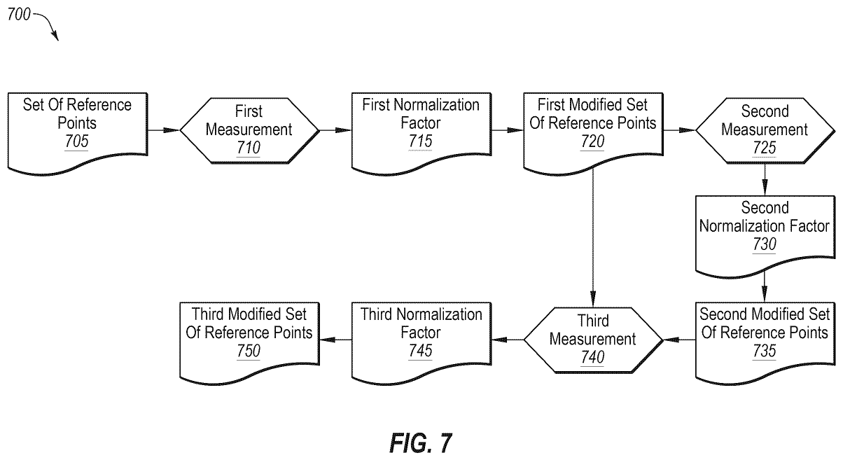

In an example operation of the normalization system 148, the normalization system 148 may obtain an image from a first sign language video, a transition video, and/or a second sign language video. The normalization system 148 may modify the images included in the first sign language video, the transition video, and/or the second sign language video such that the images included in the first sign language video, the transition video, and/or the second sign language video appear to have the same or similar image parameters and/or the same or similar subjects. For example, the subject appearing in the videos may appear to be a similar size, a similar distance from the camera, and/or at a similar scale due to the modification of the images. In another example, the subject appearing in the combined sign language video, that may be generated based on sign language videos having different subjects, may appear to be consistently sized, shaped, proportioned, and/or dimensioned throughout the combined sign language video due to the modification of the images. By modifying the images in the videos, the normalization system 148 may inhibit rendering artifacts resulting from differences in image parameters and/or differences in the subjects of the sign language videos used to generate the combined sign language video. The normalization system 148 and/or operations that may be performed by the normalization system 148 are discussed in more detail below and with reference to FIGS. 7-9.

In some embodiments, the sign language processing system 140 may perform a first translation process utilizing the sign language recognition system 142 and/or a second translation process utilizing the sign language generation system 144. The translation processes may include translation of first language data into second language data. For example, the first translation process performed by the sign language recognition system 142 may include translation of sign language into written or spoken language, and the second translation process performed by the sign language generation system 144 may include translation of written or spoken language into sign language. In these and other embodiments, the sign language processing system 140 may select the first translation process or the second translation process based on the language data received by the communication system 130. For example, in response to the language data including sign language data corresponding to signed words, the sign language processing system 140 may select the first translation process to translate the sign language into audio and/or text. In another example, in response to receiving first language data including audio data and/or text data corresponding to written or spoken language, the sign language processing system 140 may select the second translation process to generate a combined sign language video representing the words included in the audio data and/or text data. The first and/or the second translation process may be selected automatically and independently by the sign language processing system 140 in response to receiving language data.

The sign language recognition system 142 included in the sign language processing system 140 may be configured to recognize sign language in language data received at the communication system 130. For example, the sign language recognition system 142 may be configured to recognize sign language data in video obtained from the first device 110 depicting the performance of sign language. In response to receiving the language data from the first device 110, the sign language recognition system 142 may be configured to generate language data utilizing the first translation process. For example, video provided by the first device 110 to the communication system 130 may depict the first user 104 performing one or more signed words, and the sign language recognition system 142 may generate audio and/or text that may correspond to the one or more signed words depicted in the video. The audio and/or text generated by the sign language recognition system 142 may be provided to the second device 112 such that the second user 106, who may be a sign language incapable person, may read the text on the second device 112 and/or listen to the audio from the second device 112.

In some embodiments, the sign language recognition system 142 may include an AI model. The AI model may include a machine learning model, and/or a deep learning model (e.g., convolutional neural networks, recurrent neural networks, transformer models), among others. The AI model may be trained on sign language recognition data and may be configured to perform one or more of the operations described above with respect to the sign language recognition system 142. In some embodiments, a separate computer system may include the AI model and the sign language recognition system 142 may direct performance of operations by the AI model on the separate computer system.

In some embodiments, the sign language generation system 144 included in the sign language processing system 140 may be configured to generate language data based on the language data received from the second device 112. For example, in response to receiving audio and/or text data from the second device 112, the sign language generation system 144 may be configured to generate a combined sign language video based on the audio data utilizing the second translation process.

For example, the second device 112 may provide audio and/or text to the sign language generation system 144 that includes spoken and/or written words. The sign language generation system 144 may include an automated speech recognition (ASR) system that may transcribe the audio into text. The ASR system may include any configuration of hardware such as processors, servers, and storage servers that are networked together and configured to perform audio transcription. In some embodiments, the ASR may convert the audio into text data corresponding to the words spoken by the second user 106.

The sign language generation system 144 may search the data storage 150 and select sign language videos that correspond to the words in the text data. For example, the words “Yes” and “Please” may appear in the text data and the sign language generation system 144 may search the data storage for a first sign language video depicting performance of the signed word for “Yes” and for a second sign language video depicting performance of the signed word for “Please.” In some embodiments, the sign language generation system 144 may search the data storage 150 and select transition videos according to the sequence of the words appearing in the text data. For example, the words “Yes” and “Please” may appear in sequence, and the sign language generation system 144 may search the data storage 150 and select a transition video depicting performance of the movement between the end of the first sign language video depicting performance of the signed word for “Yes” and the beginning of the second sign language video depicting performance of the signed word for “Please.”

In some embodiments, the sign language videos and/or the transition video selected from the data storage 150 may be combined in a sequential order to generate a combined sign language video. For example, the frames of a first sign language video, the frames of the transition video, and the frames of a second sign language video may be placed in sequential order such that the sequence of frames depicts performance of the first signed word, then the movement between the first signed word and the second signed word, and then performance of the second signed word. For instance, the last frame of the first sign language video may be followed by the first frame of the transition video, and the last frame of the transition video may be followed by the first frame of the second sign language video. Thus, the combined sign language video may show the performance of the first signed word, the movement between the first signed word and the second signed word, and the performance of the second signed word as continuous or semi-continuous motion. In some embodiments, the sign language videos and/or the transition video may be combined unmodified to generate the combined sign language video. In some embodiments, the sign language videos and/or the transition video may be modified before the combined sign language video may be generated. For example, the sign language videos and/or the transition video may be normalized, may be modified such that the subject is the same in the sign language videos and/or the transition video, and/or may be modified such that the subject is depicted based on user input (e.g., from the first user 104 and/or the second user 106), among other modifications.

Additionally or alternately, the ASR may convert the language data received from the second device 112 into gloss. For example, the ASR may convert audio received from the second device 112 into gloss. In these and other embodiments, the sign language generation system 144 may search the data storage 150 and select sign language videos corresponding to the gloss. In some embodiments, the sign language generation system 144 may search the data storage 150 and select transition videos corresponding to the sequence of the gloss.

In some embodiments, a transition video corresponding to the movement between a first sign language video depicting a first signed word and a second sign language video depicting a second signed word may not be available in the data storage 150. In response to the transition video not being available in the data storage 150, the sign language generation system 144 may generate an interpolated transition video depicting the movement between the first signed word in the first sign language video and the second signed word in the second sign language video. An interpolated transition video may include a video generated based on a first sign language video and a second sign language video that depicts movement between a first position of a first signed word depicted in the first sign language video and a second position of a second signed word depicted in the second sign language video.

For example, the data storage 150 may not include transition videos for words that are not frequently or commonly used in sequence. For instance, the communication system 130 may obtain language data from the second device 112 including a first word “Red” and a second word “Snow.” The data storage 150 may include a first sign language video depicting performance of a first signed word corresponding to the first word “Red” and a second sign language video depicting performance of a second signed word corresponding to the second word “Snow,” but the data storage 150 may not include a transition video depicting performance of the movement between the first signed word for “Red” and the second signed word for “Snow” as these signed words may not commonly be used in sequence. In these and other instances, the interpolation system 146 included in the sign language generation system 144 may perform interpolation operations on data included in one or more images received, stored, and/or generated by the communication system 130 such that an interpolated transition video may be generated.

For example, with reference to FIG. 2B, in some instances, the transition video 240 may not be available in the data storage 150. The interpolation system 146 may use the first frame 210 of the first sign language video 200 and the second frame 230 of the second sign language video 220 to generate an interpolated transition video. For example, the interpolation system 146 may interpolate the movement of the subject 202 between the position of the subject 202 in the first frame 210 and the position of the subject 202 in the second frame 230 to generate interpolated transition frames. As a result, an interpolated transition video may be generated by the sign language generation system 144 that depicts the movement between signed words depicted in sign language videos, even when a transition video is not stored in the data storage 150.

In some embodiments, the sign language videos selected from the data storage 150 and/or the interpolated transition video may be combined in a sequential order to generate a combined sign language video. For example, the frames of a first sign language video, the frames of the interpolated transition video, and the frames of a second sign language video may be placed in sequential order such that the sequence of frames depicts performance of the first signed word, then the movement between the first signed word and the second signed word, and then performance of the second signed word. In some embodiments, the sign language videos and/or the interpolated transition video may be combined unmodified to generate the combined sign language video. In some embodiments, the sign language videos and/or the interpolated transition video may be modified before the combined sign language video may be generated. For example, the sign language videos and/or the transition video may be normalized, may be modified such that the subject is the same in the sign language videos and/or the transition video, and/or may be modified such that the subject is depicted based on user input (e.g., from the first user 104 and/or the second user 106), among other modifications.

In some embodiments, the transition videos stored in the data storage 150 may be generated by the interpolation system 146. For example, in response to a new sign language video being stored in the data storage 150, the interpolation system 146 may generate one or more transition videos between the new sign language video and one or more other sign language videos stored in the data storage 150. For example, the interpolation system 146 may generate one or more transition videos between the new sign language video and one or more other sign language videos stored in the data storage 150 where the new sign language video and the one or more other sign language videos are commonly used in sequence. In these and other embodiments, the transition videos may be generated in non-real-time.

In some embodiments, after a transition video is generated that was not previously stored in the data storage 150, such as for an uncommon sequence of words, the transition video may be stored in the data storage 150. As a result, the transition video may be found in the data storage 150 and not generated in response to not being found in the data storage. Alternately or additionally, a transition video that is generated because a transition video was not previously stored in the data storage 150, such as for an uncommon sequence of words, may not be stored in the data storage 150.

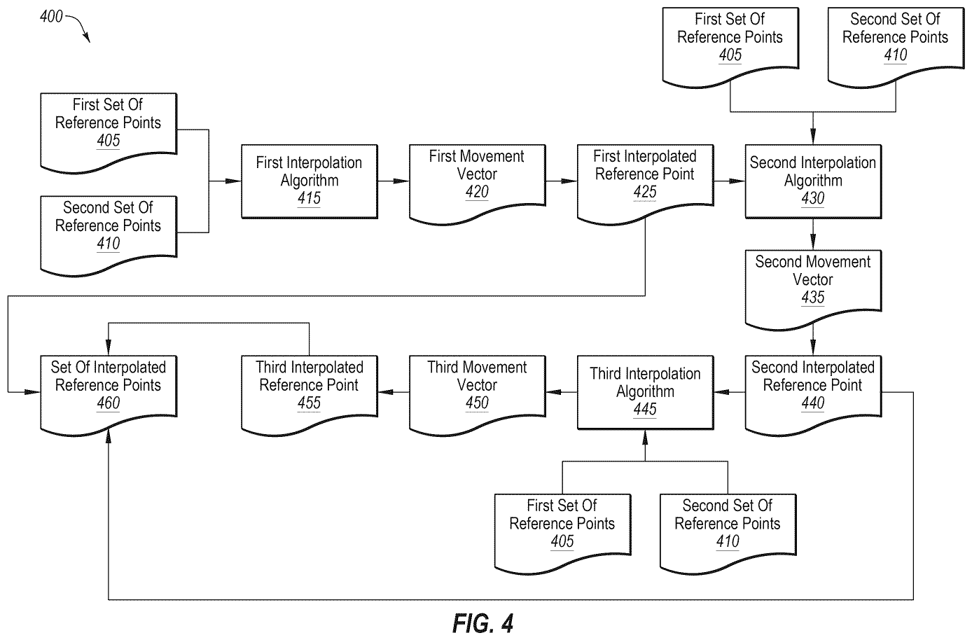

Further details regarding the interpolation system 146 and/or operations that may be performed by the interpolation system 146 are described with respect to FIGS. 4-6.

Returning to FIG. 1, after the sign language generation system 144 has selected and/or generated the sign language videos and/or the transition videos (e.g., interpolated or stored) based on the language data received from the second device 112, the sign language generation system 144 may generate a combined sign language video that depicts the performance of signed words in sequence that represents the words in the language data based on the videos. For example, the sign language generation system 144 may generate a combined sign language video based on a first sign language video depicting a subject performing a first signed word for “Yes,” a second sign language video depicting a subject performing a second signed word for “Please,” and an interpolated transition video depicting the movement of a subject between the end of the first signed word in the first sign language video and the beginning of the second signed word in the second sign language video.

The combined sign language video generated by the sign language generation system 144 may be provided to the first device 110 such that the first user 104, who may be a sign language capable person, may watch the combined sign language video depicting performance of the one or more signed words on the first device 110. In some embodiments, the combined sign language video may be provided to the first device 110 in real-time as the language data is obtained by the communication system 130 from the second device 112.

In some embodiments, the sign language generation system 144 may include an AI model. The AI model may include a machine learning model, and/or a deep learning model (e.g., convolutional neural networks, recurrent neural networks, transformer models), among others. For example, the AI model may be a generative adversarial network (GAN). The AI model may be trained on sign language generation data and may be configured to perform one or more of the operations described above with respect to the sign language generation system 144. In some embodiments, a separate computer system may include the AI model, and the sign language generation system 144 may direct performance of operations by the AI model on the separate computer system.

In an example operation of the sign language generation system 144, the sign language generation system 144 may obtain language data including a first word and a second word. For example, the sign language generation system 144 may obtain audio data from the second device 112 that includes a first word and a second word spoken by the second user 106. Based on the language data, the sign language generation system 144 may select the second translation process instead of the first translation process to generate sign language from the language data including the first word and the second word. The sign language generation system 144 may select a first sign language video depicting performance of a first signed word corresponding to the first word from the data storage 150. For example, the sign language generation system 144 may execute a search of the data storage 150 for an instance of the first word that is associated with a first sign language video, and after a successful search, may select the first sign language video. The sign language generation system 144 may select a second sign language video depicting performance of a second signed word corresponding to the second word from the data storage 150. For example, the sign language generation system 144 may execute a search of the data storage 150 for an instance of the second word that is associated with a second sign language video, and, after a successful search, may select the second sign language video.

In some embodiments, a transition video that depicts movement between the first signed word and the second signed word may be available in the data storage 150. For example, the sign language generation system 144 may execute a search of the data storage for a transition video depicting movement from the first signed word and the second signed word based on the first word and the second word occurring in sequence in the language data. In these and other embodiments, the transition video may also be obtained from the data storage 150, and the sign language generation system 144 may generate a combined sign language video that represents the first signed word and the second signed word performed in sequence based on the first sign language video, the transition video, and the second sign language video.

In some embodiments, a transition video may not be available in the data storage 150. In these and other embodiments, the sign language generation system 144 may generate an interpolated transition video based on the first sign language video and the second sign language video. The sign language generation system 144 may generate a combined sign language video that represents the first signed word and the second signed word performed in sequence based on the first sign language video, the interpolated transition video, and the second sign language video.

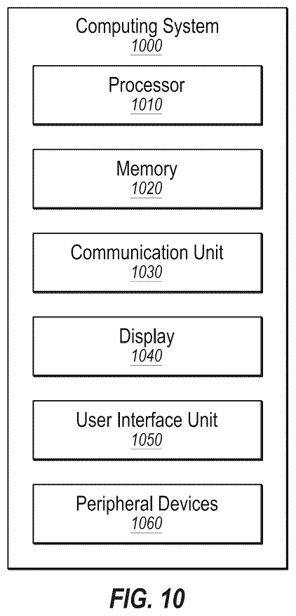

As a result, the sign language generation system 144 may generate one or more combined sign language videos corresponding to the words obtained from language data during a communication session in real-time. For example, the sign language generation system 144 may generate a combined sign language video depicting performance of words obtained from audio data that may be received from the second device 112. In some instances, there may be a small lag between when the data is received by the communication system 130 and when the sign language video is generated, however, the lag may be due to processing (e.g., by one or more components described with reference to FIG. 1 and/or FIG. 10) and delays corresponding to the lag may still be considered as being part of “real-time.” The sign language generation system 144 and/or operations that may be performed by the sign language generation system 144 are described in more detail below and with reference to FIGS. 2-4.

An example of the interaction of the elements illustrated in the environment 100 is now provided. As described below, the elements illustrated in the environment 100 may interact to establish a communication session between the first device 110 and the second device 112 to allow the first user 104 and the second user 106 to communicate.

In some embodiments, the first device 110 may send a notification to the communication system 130 requesting a communication session with the second device 112. Alternately or additionally, the first device 110 may send a notification to the second device 112, which may interact with the communication system 130. In response to the notification, the communication system 130 may establish a communication session with the second device 112.

During the communication session, first language data may be shared between the first device 110 and the communication system 130 and second language data may be shared between the second device 112 and the communication system 130. In some embodiments, the first language data may be a first type, and the second language data may be a second type that is different than the first type. For example, the first language data may be video data from a video depicting performance of one or more signed words by the first user 104, and the second language data may be audio data generated from spoken words by the second user 106. In these and other embodiments, the first language data and the second language data may be provided to the sign language processing system 140.

For example, the first device 110 may provide first video of the first user 104 that includes sign language content to the communication system 130. Sign language content may include one or more images (e.g., video frames) of a person performing one or more signed words. The sign language content may include the signed words being performed, body expressions, and other information that may be used to convey information when communicating via sign language.

The sign language recognition system 142 may select the first translation process based on the language data from the first device 110. For example, the sign language recognition system 142 may interpret the sign language in the sign language content into audio that is a translation of the sign language content. The generated audio, which may be referred to as first audio, may be directed to the second device 112. The second device 112 may broadcast the first audio to the second user 106. The second user 106 may respond to the translated audio by voicing second audio that may be captured by the second device 112. The second audio may be directed to the communication system 130.

The sign language generation system 144 may select the second translation process based on the language data received from the second device 112. For example, the sign language generation system 144 may select from the data storage 150 one or more sign language videos corresponding to the words in the second audio received from the second device 112. In some embodiments, the second audio may be converted to text, and the sign language videos may be selected based on the association of the sign language videos with specific words that may appear in the text.

In response to a transition video depicting movement between two of the words not being available in the data storage 150, the sign language generation system 144 may generate an interpolated transition video (e.g., via the interpolation system 146). In response to a transition video depicting movement between two of the words being available in the data storage 150, the sign language generation system 144 may select the transition video.

The sign language generation system 144 may generate a combined sign language video that represents the words in the second audio received from the second device 112 based on the videos (e.g., sign language videos and/or transition videos) obtained from the data storage 150 and/or the interpolated transition videos. In some embodiments, the videos obtained from the data storage 150 and/or the interpolated transition videos may be normalized by the normalization system 148 before the combined sign language video is generated and provided to the first device 110.

The combined sign language video may be directed to the first device 110. The first device 110 may be configured to present the combined sign language video to the first user 104. As a result, the first user 104 may communicate with the second user 106 using sign language, the second user 106 may communicate with the first user 104 via audio, and the communication system 130 may provide interpretation services therebetween.

In some embodiments, the sign language generation system 144 may use additional sign language videos and/or transition videos in generating the combined sign language video. For example, as audio data including a third word and a fourth word is received from the second device 112 during the communication session, the sign language generation system 144 may select and/or generate a second transition video between the second word and the third word, select a third sign language video depicting performance of a third signed word corresponding to the third word from the data storage 150, select and/or generate a third transition video between the third word and the fourth word, and/or select a fourth sign language video depicting performance of a fourth signed word corresponding to the fourth word from the data storage 150. The frames of the second transition video, the third sign language video, the third transition video, and/or the fourth sign language video may be appended to the combined sign language video in sequential order with the first sign language video, the transition video, and the second sign language video such that the combined sign language video may depict performance of each word and the movement between each signed word during the communication session.

For example, the sign language generation system 144 may use additional sign language videos and/or transition videos in generating a combined sign language video that depicts the signed words corresponding to a sentence in the language data provided by the second device 112. For instance, the sentence “What is your favorite animal?” may correspond to four signed words as the word “is” may be omitted in ASL, and the sign language videos corresponding to the words “What”, “Your,” “Favorite”, and “Animal” as well as the respective transition videos may be used in generating the combined sign language video.

In some embodiments, the sign language generation system 144 may generate multiple combined sign language videos. For example, the sign language generation system 144 may generate a combined sign language videos for each sentence in the language data provided by the second device 112. For instance, the sign language generation system 144 may generate a first combined sign language video for a first sentence and second combined sign language video for a second sentence.

As another example, the first device 110 may provide first video of the first user 104 that includes sign language content to the communication system 130. The sign language recognition system 142 may select the first translation process based on the sign language content and interpret the sign language in the sign language content to generate audio that is a translation of the sign language content. The generated audio, which may be referred to as first audio, may be converted to first text.

As an example, the first audio may be converted to first text using automated speech recognition or any other form of conversion. The first text may be directed to the second device 112 and presented by the second device 112. The second device 112 may obtain second text from the second user 106 in response to the first text. The second text may be directed to the first device 110 and presented to the first user 104. Alternately or additionally, the second text may be directed to the communication system 130. The communication system 130 may select the second translation process based on the text and generate a combined sign language video via the sign language generation system 144 that represents the second text. The combined sign language video may be directed to the first device 110 and presented to the first user 104.

Other configurations of language data may be shared between the first device 110 and the second device 112. For example, the second device 112 may obtain audio in response to the first text. The communication system 130 may generate a sign language video via the sign language generation system 144 that represents the audio.

Modifications, additions, or omissions may be made to the environment 100 without departing from the scope of the present disclosure. For example, the environment 100 may include additional devices, such as additional devices similar to the first device 110 or the second device 112. In these and other embodiments, the language data from each of the devices or some of these devices may be provided to the sign language processing system 140.

In some embodiments where the third network 102c, the third device 114, and the third user 108 are included in the environment 100, the communication system 130 may establish a communication session between the first device 110, the second device 112, and the third device 114. In these and other embodiments, the first device 110 may be communicating with the third device 114 and the second device 112 may be communicating with the third device 114. In some embodiments, the communications between the first device 110 and the third device 114 may be through the communication system 130 or may occur directly between the first device 110 and the third device 114. In these and other embodiments, the communications between the second device 112 and the third device 114 may be through the communication system 130 or may occur directly between the second device 112 and the third device 114.

In these and other embodiments, the communication system 130 may be configured to direct the combined sign language video and/or the generated audio to the third device 114, which may present the combined sign language video and/or the generated audio to the third user 108. In these and other embodiments, the third user 108 may validate the accuracy of the generated audio from the sign language recognition system 142 and/or validate the accuracy of the combined sign language video from the sign language generation system 144. For example, the third user 108 may determine whether the generated audio is an accurate translation of the sign language in the first video provided by the first device 110. In another example, the third user 108 may determine whether the combined sign language video is an accurate translation of the second audio received from the second device 112.

In some embodiments, the first device 110, the second device 112, and/or the third device 114 may provide language data to each other and/or to the communication system 130. For example, the first device 110 may provide first video of the first user 104 that includes sign language content to the third device 114. In these and other embodiments, the third device 114 may present the first video to the third user 108 via the third device 114. The third user 108 may interpret the sign language in the sign language content into voiced audio (e.g., spoken audio) that is a translation of the sign language content. The third device 114 may capture the voiced audio. The voiced audio, which may be referred to as first audio, may be directed to the second device 112 via the communication system 130 or directly from the third device 114. The second device 112 may broadcast the first audio to the second user 106. The second user 106 may respond to the translated audio by voicing second audio that may be captured by the second device 112. The second audio may be directed to communication system 130 from the second device 112 directly or via the third device 114. As described above, the communication system 130 may generate a combined sign language video depicting performance of signed words corresponding to the spoken words in the second audio. The combined sign language video may be directed to the first device 110. The first device 110 may be configured to present the combined sign language video to the first user 104. As a result, in these and other embodiments, the first user 104 may communicate with the second user 106 using sign language, the second user 106 may communicate with the first user 104 via audio, the third user 108 may perform interpretation of the language data provided by the first user 104 (e.g., translate sign language into written and/or spoken language), and the communication system 130 may perform interpretation of the language data provided by the second user 106. In these and other embodiments, the sign language recognition system 142 may be omitted.

As discussed previously, in some embodiments, the third network 102c, the third device 114, and the third user 108 may be omitted from the environment, which may allow the first user 104 and the second user 106 to engage in a communication session without a third party present.

In some embodiments, at least some of the operations performed by the sign language recognition system 142 and/or the sign language generation system 144 including those operations performed by the interpolation system 146 and/or the normalization system 148 may be performed by a computer system separate from the communication system 130. For example, the normalization operations performed by the normalization system 148 may be performed on the sign language videos and/or transition videos stored in the data storage 150 before the videos are stored in the data storage 150 by a computer system separate from the communication system 130.

In some embodiments, the interpolation system 146 and/or the normalization system 148 may be omitted. For example, the normalization system 148 may be omitted, and the communication system 130 may provide a combined sign language video that may be generated based on sign language videos and/or transition videos that have not been normalized. In another example, the interpolation system 146 may be omitted, and the communication system 130 may provide transition videos that are stored in the data storage 150. In these and other embodiments, in response to a transition video not being present in the data storage 150, the communication system 130 may provide the stored sign language videos depicting performance of the signed words without providing a transition video.

In some embodiments, the communication system 130 or the first device 110 may be further configured to alter the video generated by the first device 110. For example, the first user 104 may not want every feature of the first user 104 to be part of the video that is provided to the third device 114 and/or the communication system 130. In these and other embodiments, either the first device 110 or the communication system 130 may be configured to alter the video based on input obtained from the first user 104. In these and other embodiments, the first user 104 may select or deselect alteration of the video to present the alteration or not present the alteration during the video. Alteration of the video may include altering a background, altering one or more characteristics of the first user 104 as illustrated in the video. For example, the video may be altered to modify facial, body, or other features of the first user 104. For example, the first user 104 may be obscured. In these and other embodiments, facial landmarks (e.g., eyebrow angle or lip distance on the face) may be preserved to allow the third user 108 to read facial expressions but other elements may be discarded that make the person recognizable. Alternately or additionally, emotion tags (e.g., “happy,” “concerned,” etc.) may be preserved instead of landmarks. Alternately or additionally, other parts of the first user 104 or an entirety of the first user 104 may be obscured and landmarks to allow interpretation of signs may be maintained.

In some embodiments, the video may be altered to replace the first user 104 in the video with an avatar of the first user 104. The avatar may mimic the movements of the first user 104 such that avatar performs the sign language that the first user 104 performs. Furthermore, the avatar may mimic facial expressions or other emotions conveyed by the first user 104. In these and other embodiments, the avatar may be generated by analyzing the video to determine the movements of the user and mapping the movements of the avatar to match the movements of the first user 104.

In some embodiments, the characteristics of the avatar may be varied based on input obtained from the first user 104. For example, the avatar may be a 2-D or 3-D cartoon, a photorealistic avatar featuring the face of the first user 104, an enhanced (better looking) version of the first user 104, a figure designed by the first user 104 by specifying the hairstyle, clothing, eye color, and other features meant to represent the first user 104, a character such as a wizard, a skeleton of a subject, the image of another person such as a celebrity, an image selected by the first user 104 from a menu of options, a stick figure, an art deco or graphic art image, an animal, a plant, a character from a movie, or an inanimate object such as a stuffed animal or a toy.

In some embodiments, the combined sign language video may be generated based on input obtained from the first user 104 or the second user 106. For example, the second user 106 may select an avatar to use in the combined sign language video. In some embodiments, the selected avatar may have associated sign language videos for signed words stored in the data storage 150. In some embodiments, the sign language videos may be generated by the sign language generation system 144 based on the selected avatar. For example, the data storage 150 may store sets of reference points that correspond to signed words and the reference points may be adjusted based on the selected avatar. For example, reference points may correspond to specific positions of the avatar to depict a particular portion of a signed word.

In some embodiments, reference images may be stored in the data storage 150 that correspond to the one or more subjects depicted in the stored sign language videos, and/or subjects that may be selected based on user input. A reference image may encompass an image that depicts a subject, which may be used to modify other images that depict the same subject or a different subject. For example, reference points of the sign language videos corresponding to the words received from the second device 112 and/or transition videos may be modified based on the reference image of the selected avatar as is described in more detail with reference to FIGS. 7-9.

The avatar selection options for the second user 106 may be the same as the avatar selection options of the first user 104 or the avatar selection options may be different. In these and other embodiments, the interpolation system 146 may interpolate between sign language videos of the selected avatar performing signed words.

In some embodiments, the sign language generation system 144 may generate images for the combined sign language video based on the characteristics of the second user 106. For example, characteristics of the second user 106 may be provided to the communication system 130 by the second device 112 or the first device 110. For example, the first device 110 may have stored characteristics of users in their contacts that may be provided to the communication system 130 when the first device 110 requests a communication session with the second device 112. Alternately or additionally, the characteristics may be obtained from an account of the second user 106, from information stored in the communication system 130, from information about the second user 106 from online sources, such as social media, among other sources. In some embodiments, the characteristics may be derived from one or more pictures or videos of the second user 106. Alternately or additionally, the characteristics may include a description of the second user 106. The description may include hair color and length, age, skin color, apparent ethnicity, and a description of any facial hair, glasses, clothing, or jewelry, among others. In these and other embodiments, the sign language generation system 144 may generate an avatar based on the characteristics of the second user 106 that may be used to produce the sign language in the combined sign language video that may be provided to the first device 110.

In some embodiments, the communication system 130 may be configured to provide video to both the third device 114 and the second device 112. In these and other embodiments, the video provided to the third device 114 and the second device 112 may be altered for both or one of the third device 114 and the second device 112. Alternately or additionally, the communication system 130 may be configured to allow two sign language capable people to communicate. For example, the communication system 130 may provide video conferencing between the first device 110 and the second device 112 without the third device 114. In these and other embodiments, the video from each of the first device 110 and the second device 112 may be altered as discussed above.

In some embodiments, the communication system 130 may be configured to alter the language data to remove personal or sensitive information before video and/or audio is provided to the sign language processing system 140. For example, the sign language recognition system 142 may be configured to determine words, signs, or phrases in the audio and/or video being provided to the sign language processing system 140 that contain potentially sensitive or personal information. Potentially sensitive or personal information may include a Social Security number, physical address, zip code, birth date, credit card information, driver's license number, passport number, bank account number, health information, employment status or history, email address, phone numbers, any numeric string, names, medical conditions or treatments, and biometric data.

In some embodiments, other actions may be performed with respect to the third device 114 and/or the communication system 130. For example, video from the first device 110 may be in American sign language (ASL). The audio captured by the third device 114 and/or generated by the communication system 130 may be any language. As such, the third user 108 and/or the communication system 130 may translate between language types, such as sign language and spoken language, and between different forms of the language type, such as between different spoken languages, such as Spanish, French, English, Chinese, Japanese, German, etc. Alternately or additionally, the communication system 130 may be configured to recognize and/or generate different sign languages. For example, the sign language recognition system 142 may be configured to recognize ASL and Chinese sign language, and/or the sign language generation system 144 may be configured to generate ASL and Chinese sign language. In these and other embodiments, a different spoken language than the sign language may be provided to the sign language processing system 140, but the sign language processing system 140, the communication system 130, or another system may translate the different spoken language to be the same language as the sign language.

In some embodiments, the sign language processing system 140, and/or the data storage 150 may not be part of the communication system 130. In these and other embodiments, the sign language processing system 140, and/or the data storage 150 may be networked to the communication system 130. Alternately or additionally, the sign language processing system 140, and/or the data storage 150 may be part of the first device 110, the second device 112, the third device 114, or some other device. Alternately or additionally, the sign language processing system 140, and/or the data storage 150 may be distributed across multiple different devices.

In some embodiments, a communication session may include multiple second devices 112 and/or multiple first devices 110. In these and other embodiments, the communication system 130 may be configured to identify the source of the language data for each of the other devices participating in the communication session. In these and other embodiments, the sign language recognition system 142 may use different voices in the audio generated for the different first users. Alternately or additionally, the sign language generation system 144 may use different avatars in the videos generated for the different second users 106

In some embodiments, multiple second users 106 may be participating via a single second device 112. In these and other embodiments, the communication system 130 and/or the second device 112 may be configured to determine which of the second users 106 are speaking at a given time. For example, the communication system 130 may obtain video from the second device 112 and determine which of the second users 106 are speaking based on the video. Alternately or additionally, the communication system 130 or the second device 112 may be configured to discern different speakers in the audio using diarization. In these and other embodiments, the sign language generation system 144 may generate different avatars when the different second users 106 are speaking. Alternately or additionally, the sign language generation system 144 may generate avatars for each of the different second users 106 at the same time and presented at the same time and have one of the avatars perform sign language based on which of the different second users 106 are speaking.

As described above, FIG. 2A illustrates the first frame 210 of the first sign language video 200 and the second frame 230 of the second sign language video 220.

The first frame 210 may depict the subject 202 in a first position, and the second frame 230 may depict the subject 202 in a second position. The first position may correspond to a portion of the first signed word, and the second position may correspond to portion of the second signed word. For example, the first position may correspond to an ending position of a first signed word, and the second position may correspond to a beginning position of a second signed word. In some embodiments, the first frame 210 may be an end frame of the first sign language video 200 such as one of the last two, three, four, or five frames of the first sign language video 200, and/or the second frame 230 may be a beginning frame such as one of the first two, three, four, or five frames of the second sign language video 220. In some embodiments, the first frame 210 may be the last frame of the first sign language video 200, and/or the second frame 230 may be the first frame of the second sign language video 220.

The first signed word depicted by the first sign language video 200 may correspond to a first word obtained from language data, and the second signed word depicted by the second sign language video 220 may correspond to a second word obtained from language data. For example, the first word and the second word may be obtained from language data by a system configured to generate, in real-time, a combined sign language video representing the first word and the second word, such as in the environment 100 of FIG. 1.

In some embodiments, the subject 202 may be a human, an avatar, a figure, or any other subject. As illustrated in FIG. 2A, the subject 202 may be represented by a skeleton. A skeleton may include a basic structure of a subject 202 that may not be in a final form. For example, a skeleton may include reference points, segments (e.g., segments connecting reference points), or other elements that may correspond to the basic structure and/or movement of the subject 202 without showing the subject 202 in full detail. For instance, specific body features, facial features, accessories, and/or clothing may not be shown on a skeleton.

The subject 202 may include a first portion 204a, a second portion 204b, a third portion 204c, and a fourth portion 204d. The portions 204 may be coupled together such that movement of one portion may affect movement of another portion. For example, the first portion 204a and the second portion 204b may be coupled, and the second portion 204b and the third portion 204c may be coupled. For instance, a first end of the first portion 204a may be coupled to a second end of the second portion 204b, and a third end of the second portion 204b that is opposite the second end of the second portion 204b may be coupled to a fourth end of the third portion 204c. In some embodiments, the fourth portion 204d may be coupled to the first portion 204a. In some embodiments, the subject 202 may include multiple first portions 204a, second portions 204 b, and/or third portions 204 c. In some embodiments, the subject 202 may include multiple fourth portions 204d.

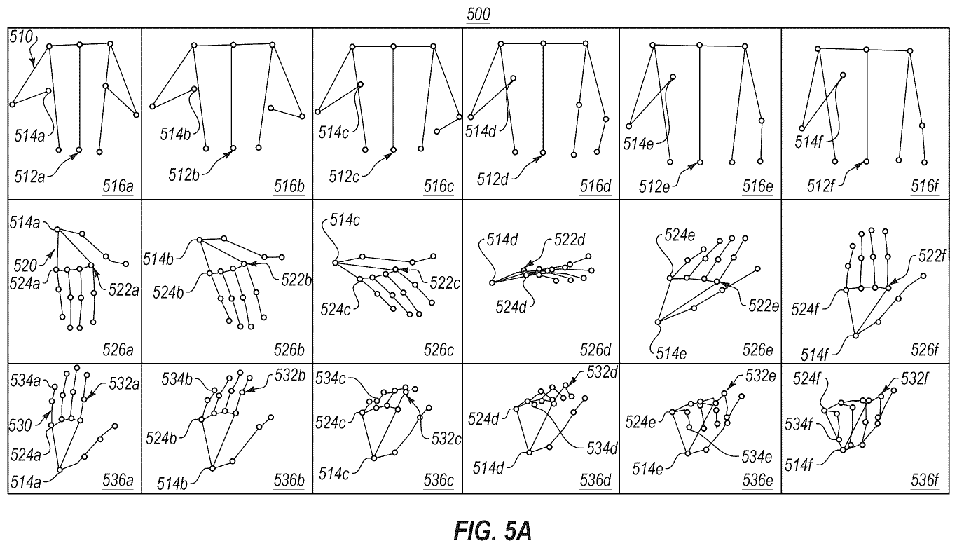

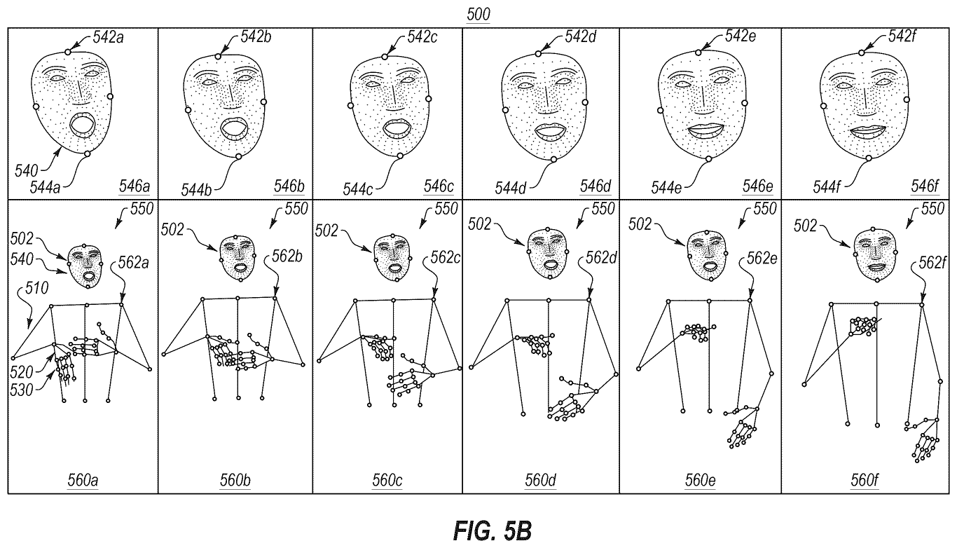

The first portion 204a, the second portion 204b, the third portion 204c, and the fourth portion 204d may respectively correspond to the first portion 510, the second portion 520, the third portion 530, and/or the fourth portion 540 illustrated and described with respect to FIGS. 5A and 5B.

In some embodiments, the subject 202 may have a body, and the portions 204 may include various body parts. In some embodiments, the first portion 204a may include wrists, the second portions 204b may include hands, and/or the third portions 204c may include fingers. For example, each hand of each second portion 204b may be connected to a respective wrist of the first portion 204a, and each finger of a third portion 204c may be connected to a respective hand of a second portion 204b. In some embodiments, the first portion 204a may include a shoulder joint, an elbow joint, and a wrist joint. In some embodiments, the second portion 204b may include a hand having fist nodes (e.g., the portion of the hand to which the fingers are connected). In some embodiments, the third portion 204c may include one or more finger joints such as a base knuckle joint, a middle knuckle joint, and/or a tip joint. The fourth portion 204d may include a head, and the head may be connected to the first portion 204a and/or positioned above the first portion 204a. For example, the subject 202 may be a skeleton, and the head of the fourth portion 204d may be spatially related to the first portion 204a, but the coupling between the fourth portion 204d and the first portion 204a may be omitted.

A first set of reference points 206 may be obtained from the first frame 210, and a second set of reference points 208 may be obtained from the second frame 230. For example, the first set of reference points 206 may be extracted from the first frame 210 and the second set of reference points 208 may be extracted from the second frame 230. The reference points in the first set of reference points 206 and the second set of reference points 208 may be numerical vectors having coordinates associated with various portions 204 of the subject 202. In some embodiments, the coordinates may be two-dimensional (e.g., (X, Y)), the coordinates may be three-dimensional (e.g., X, Y, Z)), or some other coordinate system. In some embodiments, the X-direction may represent left-to-right position in a frame, the Y-direction may represent top-to-bottom position in a frame, and/or the Z-direction may represent distance from the camera (e.g., a real or hypothetical camera). In some embodiments, the origin of the coordinates may be the center of the frame, the top-left corner of each frame, the top-right corner of each frame, the bottom-left corner of each frame, the bottom-right corner of each frame, or any other position in the frames.

The first set of reference points 206 may correspond to the subject 202 in the first position, and the second set of reference points 208 may correspond to the subject 202 in the second position. The reference points in the first set of reference points 206 and the second set of reference points 208 may correspond to various portions 204 of the subject 202. For example, the first portion 204a, the second portions 204b, the third portions 204c, and/or the fourth portion 204d may have corresponding reference points in the first set of reference points 206 and the second set of reference points 208. In some embodiments, the first portion 204a may include reference points corresponding to a shoulder joint, an elbow joint, and/or a wrist joint of the subject 202 in the first set of reference points 206 and the second set of reference points 208. In these and other embodiments, the second portions 204b may include reference points corresponding to a hand of the subject 202 in the first set of reference points 206 and the second set of reference points 208. In these and other embodiments, the third portions 204c may include reference points corresponding to finger joints such as a base knuckle joint, a middle knuckle joint, and/or a tip joint in the first set of reference points 206 and the second set of reference points 208. In some embodiments, the fourth portion 204d may have reference points corresponding to a head of the subject 202 in the first set of reference points 206 and the second set of reference points 208.

In some embodiments, in response to a reference point being missing from the first set of reference points 206 obtained using the first frame 210 and/or in response to a reference point being missing from the second set of reference points 208 obtained using the second frame 230, the missing reference point may be obtained using a different frame and associated with the first set of reference points 206 and/or the second set of reference points 208. For example, in response to a reference point being missing from the first set of reference points 206, the missing reference point may be obtained using a different frame of the first sign language video 200 such as an adjacent frame to the first frame 210, and/or in response to a reference point being missing from the second set of reference points 208, the missing reference point may be obtained using a different frame of the second sign language video 220 such as an adjacent frame to the second frame 230. In some embodiments, the first set of reference points 206 may be obtained using at least one of the last two, three, four, or five frames of the first sign language video 200, and the second set of reference points 208 may be obtained using at least one of the first two, three, four, or five frames of the second sign language video 220.

In some embodiments, the first set of reference points 206 and the second set of reference points 208 may be utilized in interpolating the movement of the subject 202 between the first position of the subject 202 depicted in the first frame 210 and the second position of the subject 202 depicted in the second frame 230. For example, the position of the reference points corresponding to the subject 202 at various stages in the movement of the subject 202 between the first frame 210 and the second frame 230 may be determined based on the position of the reference points in the first frame 210 and the second frame 230. The interpolation is described in more detail with respect to FIG. 2B and with respect to FIGS. 4-6.

FIG. 2B illustrates a sequence of frames from a combined sign language video 260 generated based on the first sign language video 200, a transition video 240, and the second sign language video 220. As illustrated in FIG. 2B, the transition video 240 may depict the movement of the subject 202 between the first position of the subject 202 in the first frame 210 of the first sign language video 200 and the second position of the subject 202 in the second frame 230 of the second sign language video 220. For example, the transition video 240 may depict the subject 202 at various positions corresponding to different stages of movement of the subject 202 between the first frame 210 and the second frame 230.

The transition video 240 may include two or more transition frames 250 that may be formed to generate the transition video 240. For example, as illustrated in FIG. 2B, the transition video 240 may include a first transition frame 250a, a second transition frame 250b, a third transition frame 250c, a fourth transition frame 250d, a fifth transition frame 250e, and a sixth transition frame 250f. The number of transition frames 250 may vary based on the frame rate, the first sign language video 200, the second sign language video 220, among other factors.

In some embodiments, the transition frames 250 may correspond to different positions of the subject 202 corresponding to the movement of the subject 202 between the first signed word and the second signed word. For example, the transition frames 250 may correspond to different positions of the subject 202 between the first position depicted by the first frame 210 (e.g., corresponding to a portion of the first signed word) and the second position depicted by the second frame 230 (e.g., corresponding to a portion of the second signed word). For instance, the first transition frame 250a may correspond to the subject 202 at a third position between the first position and the second position.

In some embodiments, each of the transition frames 250 may be interpolated transition frames that represent a different interpolated position between the first position of the subject 202 depicted by the first frame 210 and the second position of the subject 202 depicted by the second frame 230. For example, the first transition frame 250a may represent a first interpolated position between the first position of the subject 202 in the first frame 210 and the second position of the subject 202 in the second frame 230.

In some embodiments, some of the transition frames 250 may be generated via interpolation using at least one other transition frame 250. For example, after the first transition frame 250a is generated, the first transition frame 250a and the second frame 230 may be used to generate the second transition frame 250b.

In some embodiments, the transition frames 250 may be generated based on sets of interpolated reference points 212 that may be created by interpolating between the first set of reference points 206 and the second set of reference points 208. The interpolation between the first set of reference points 206 and the second set of reference points 208 to generate the sets of interpolated reference points 212 is described in more detail with reference to FIGS. 4-6.

In some embodiments, each of the transition frames 250 may include a different set of interpolated reference points 212. Each set of interpolated reference points 212 may correspond to the subject 202 in a different interpolated position between the first position of the subject 202 depicted by the first frame 210 and the second position of the subject 202 depicted by the second frame 230. For example, a first set of interpolated reference points 212a may correspond to a first interpolated position in the first transition frame 250a. A second set of interpolated reference points 212b may correspond to a second interpolated position in the second transition frame 250b. A third set of interpolated reference points 212c may correspond to a third interpolated position in the third transition frame 250c. A fourth set of interpolated reference points 212d may correspond to a fourth interpolated position in the fourth transition frame 250d. A fifth set of interpolated reference points 212e may correspond to a fifth interpolated position in the fifth transition frame 250e. A sixth set of interpolated reference points 212f may correspond to a sixth interpolated position in the sixth transition frame 250f. The reference points in each set of interpolated reference points 212 may correspond to various portions 204 of the subject 202. For example, the first portion 204a, the second portion 204b, the third portion 204c, and/or the fourth portion 204d may have corresponding reference points in each set of interpolated reference points 212.

In some embodiments, some of the sets of interpolated reference points 212 may be created via interpolation using at least one other set of interpolated reference points 212. For example, after the first set of interpolated reference points 212a is created, the first set of interpolated reference points 212a and the second set of reference points 208 may be used to generate the second set of interpolated reference points 212b.

In some embodiments, the sets of interpolated reference points 212 may be utilized to generate the transition frames 250. For example, the first set of interpolated reference points 212a, the second set of interpolated reference points 212b, the third set of interpolated reference points 212c, the fourth set of interpolated reference points 212d, the fifth set of interpolated reference points 212e, and the sixth set of interpolated reference points 212f may be respectively utilized to generate the first transition frame 250a, the second transition frame 250b, the third transition frame 250c, the fourth transition frame 250d, the fifth transition frame 250e, and the sixth transition frame 250f, respectively. As illustrated in FIG. 2B, in some embodiments, at least some of the interpolated reference points of each set of interpolated reference points 212 may be connected via one or more segments to form a skeleton representing the subject 202 in the transition frames 250.

Thus, the transition frames 250 may be interpolated transition frames generated from sets of interpolated reference points 212, and the transition frames 250 may be utilized to generate the transition video 240.

In some embodiments, after the transition video 240 has been generated, the combined sign language video 260 may be generated based on the first sign language video 200, the transition video 240, and the second sign language video 220. For example, the combined sign language video 260 may be generated based on the first frame 210 and any other frames of the first sign language video 200, the transition frames 250, and the second frame 230 and any other frames of the second sign language video 220 such that the combined sign language video 260 may depict the subject 202 performing the first signed word, the movement between the first signed word and the second signed word, and the second signed word in sequential order.

In some embodiments, the first frame 210 and any other frames of the first sign language video 200, the transition frames 250, and the second frame 230 and any other frames of the second sign language video 220 may be provided to an AI model such as a GAN. In these and other embodiments, the GAN may generate the combined sign language video 260. In some embodiments, the transition frames 250 may be generated by the AI model based on the first set of reference points 206, the second set of reference points 208, and/or the set of interpolated reference points 212.

In some embodiments, the AI model may generate the combined sign language video 260 using the first set of reference points 206, the second set of reference points 208, and/or the sets of interpolated reference points 212.

In these and other embodiments, the AI model may define the structure of the subject 202 to be depicted in the combined sign language video 260 based on the reference points and/or the interpolated reference points. For example, the AI model may define the structure of the subject 202 in the first position based on the first set of reference points 206, define the structure of the subject 202 in the second position based on the second set of reference points 208, and/or define the structure of the subject 202 at the interpolated positions based on the sets of interpolated reference points 212. Alternately or additionally, the AI model may define a skeleton representing the subject 202 at the first position based on the first set of reference points 206, at the second position based on the second set of reference points 208, and/or at the interpolated positions based on the sets of interpolated reference points 212.

In some embodiments, the structure of the subject 202 in the first sign language video 200, the second sign language video 220, and/or the transition video 240 may be defined before the reference points and/or the interpolated reference points may be provided to the AI model. For example, the structure of the subject 202 in the first sign language video 200, the second sign language video 220, and/or the transition video 240 may be determined based on user input received during the communication session.

In these and other embodiments, the AI model may generate the combined sign language video 260 depicting the subject 202 in greater detail using the skeletons representing the subject 202. For example, the AI model may construct the appearance, features, clothing, and/or other details associated with the subject 202 based on the structure provided by the skeleton. In some embodiments, the additional detail may be based on the subject 202 depicted in the first sign language video 200, the subject 202 depicted in the second sign language video 220, a subject depicted in another sign language video, and/or a subject selected based on user input. For example, the details associated with the subject 202 depicted in the first sign language video 200, the subject 202 depicted in the second sign language video 220, a subject depicted in another sign language video, and/or a subject selected based on user input, may be used to construct the combined sign language video 260 using the skeleton representing the subject 202 in the first sign language video 200, the skeleton representing the subject 202 in the second sign language video 220, and/or the skeleton representing the subject 202 in the transition video 240 as a basis for movement of the subject 202 in the combined sign language video 260. For instance, the body shape, size, and appearance of the subject 202 for the combined sign language video 260 may be constructed using the skeletons as a base structure.

As noted previously, in some embodiments, the subject 202 in the first sign language video 200 and the second sign language video 220 may be different, and modifying the form of the subject 202 (e.g., male, female, avatar, among other forms of the subject 202) depicted in the first sign language video 200 and/or the second sign language video 220 may be desirable such that the subject 202 may be depicted consistently in the combined sign language video 260. Furthermore, as discussed previously, the subject 202 depicted in the combined sign language video 260 may be determined based on user input. In these and other embodiments, the reference points (e.g., the first set of reference points 206, the second set of reference points 208, and/or the sets of interpolated reference points 212) may be normalized before being provided to the AI model and/or may be normalized by the AI model. Normalization is described in further detail with respect to FIGS. 7-9.

For example, the first sign language video 200 may depict a male subject and the second sign language video 220 may depict a female subject. To ensure the subject 202 may be consistently depicted in the combined sign language video 260, the AI model may use the reference points (e.g., the second set of reference points 208) and/or the skeletons corresponding to the second sign language video 200 as a basis for movement of the male subject in the first sign language video 200 and use the details of the male subject in the first sign language video 200 to construct the male subject in the second sign language video 220. The AI model may also use the details of the male subject with the sets of interpolated reference points 212 and/or the skeletons corresponding to the transition video 240, such that the transition video 240 depicts a male subject. Thus, the combined sign language video 260 may depict the same male subject performing the signed words and the movement between the signed words.

In another example, the first user 104 may choose a particular avatar to sign words to the first user 104 during the communication session and/or the second user 106 may choose a particular avatar to sign their spoken and/or written words to the first user 104 during the communication session. The reference points, and/or skeletons corresponding to the first sign language video 200 and the second sign language video 220, and the interpolated reference points and/or skeletons corresponding to the transition video 240 as described above may be used as a basis for the movement of the avatar. In these and other embodiments, the AI model may generate the combined sign language video 260 to depict the selected avatar performing the signed words and the movement between the signed words.

As a result, the combined sign language video 260 may depict the subject 202 consistently even when the subject 202 is different in the first sign language video 200 and the second sign language video 200 and/or when the subject 202 is selected based on user input.

In some embodiments, the subject 202 in the first sign language video 200 and the second sign language video 220 may be the same. In these and other embodiments, the sets of interpolated reference points 212 may be provided to the AI model, and the AI model may use the detail of the subject 202 depicted in the first sign language video 200 and/or the second sign language video 220 and the sets of interpolated reference points 212 and/or structures (e.g., skeletons) based on the sets of interpolated reference points 212 as described above to generate the combined sign language video 260. In these and other embodiments, the interpolated sets of reference points 212 may be provided to the AI model, but the first set of reference points 206 and the second set of reference points 208 may not. For example, the AI model may generate the transition video 240 based on the sets of interpolated reference points 212 and may generate the combined sign language video 260 using the transition video 240, the first sign language video 200, and the second sign language video 200 without receiving the first set of reference points 206 and the second set of reference points 208.

In an example operation of generating the combined sign language video 260, the first sign language video 200, that may depict the subject 202 performing a first signed word corresponding to a first word, and the second sign language video 220, that may depict the subject 202 performing a second signed word corresponding to a second word, may be selected from a data storage such as the data storage 150 of FIG. 1. For example, the first sign language video 200 may depict the subject 202 performing a first signed word corresponding to the word “Yes,” and the second sign language video 220 may depict the subject 202 performing a second signed word corresponding to the word “Please.”

The data storage may be searched to determine whether the transition video 240 between the first position of the subject 202 in the first sign language video 200 and the second position of the subject 202 in the second sign language video 220 is available in the data storage.

In some embodiments, the transition video 240 may be obtained from the data storage in response to obtaining data including the first and second words. For example, the transition video 240 may depict the movement of the subject 202 between the first signed word for “Yes” and the second signed word for “Please,” and the transition video 240 may be available in the data storage.

In some embodiments, the transition video 240 may not be available in the data storage and the transition video 240 may be generated using the first sign language video 200 and the second sign language video 220. As an example, the transition video 240 may be generated by interpolating the movement of the subject 202 between the first sign language video 200 and the second sign language video 220. In some embodiments, transition frames 250 may be generated from the first frame 210 and the second frame 230 based on interpolation between the first set of reference points 206 and the second set of reference points 208.

After the transition video 240 has been obtained or generated, the combined sign language video 260 may be generated based on the first sign language video 200, the second sign language video 220, and the transition video 240 as described above. As a result, translation of language data such as audio into sign language in real-time may occur as language data is obtained

Furthermore, in some embodiments where a transition video 240 is unavailable, the combined sign language video 260 may still be generated in real-time as language data is obtained. Consequently, communication sessions between a sign language capable person and a sign language incapable person may be enabled without the use of a third party for interpretation.

Modifications, additions, or omissions may be made to the elements illustrated in FIG. 2A and FIG. 2B without departing from the scope of the present disclosure. For example, a single frame from each of the first sign language video 200 and the second sign language video 220 is illustrated as being used to generate the transition video 240, but, in some embodiments, multiple frames from the first sign language video 200 and/or the second sign language video 220 may be used to generate the transition video 240.

Furthermore, in some embodiments, the combined sign language video 260 may be generated using additional transition videos and/or additional sign language videos. For example, as audio data including additional words is received, additional transition videos and/or additional sign language videos may be selected from the data storage and/or generated.

In some embodiments, multiple combined sign language videos 260 may be generated. For example, a combined sign language video 260 may be generated for each sentence appearing in the language data, for each paragraph appearing in the language date, until a pause is detected in the language data received from the second device, and/or until the first user of the first device begins signing in response to the second user.

In some embodiments, the subject 202 may reset at the start of each combined sign language video 260. In some embodiments, the subject 202 resetting may include the subject 202 terminating movement at an ending position of a final signed word in a first combined sign language video and restarting movement at a beginning position of a first signed word in a second combined sign language video. For example, a first combined sign language video may end at the end of a first sentence, and a second combined sign language video may begin at the start of a second sentence with no transition between the position of the subject 202 at the end of first combined sign language video and the position of the subject 202 at the beginning of the second combined sign language video.

In some embodiments, the subject 202 may not reset at the start of each combined sign language video 260. For example, a transition video 240 may be provided between each combined sign language video. For example, a transition video 240 may be provided between combined sign language videos that may correspond to different sentences.

In some embodiments, the subject 202 may include a higher number or a lower number of portions 204 than illustrated in FIG. 2A and FIG. 2B. In some embodiments, the subject 202 depicted in the first frame 210, the transition frames 250, and/or the second frame 230 may include more or less detail than the subject 202 illustrated in FIG. 2A and FIG. 2B.

In some embodiments, a higher number or a lower number of transition frames 250 may be generated than illustrated in FIG. 2B. For example, a smaller number of transition frames 250 or a larger number of transition frames 250 may be generated depending on the distance that the subject 202 moves between the first position of the subject 202 depicted in the first frame 210 and the second position of the subject 202 depicted in the second frame 230. For instance, a smaller number of transition frames 250 may be generated for a smaller distance of hand movement, and/or a larger number of transition frames 250 may be generated for a larger distance of hand movement.

Furthermore, in some embodiments, a higher number or lower number of reference points may be utilized and/or different reference point locations may be utilized than the amount and/or locations illustrated in FIGS. 2A and 2B.

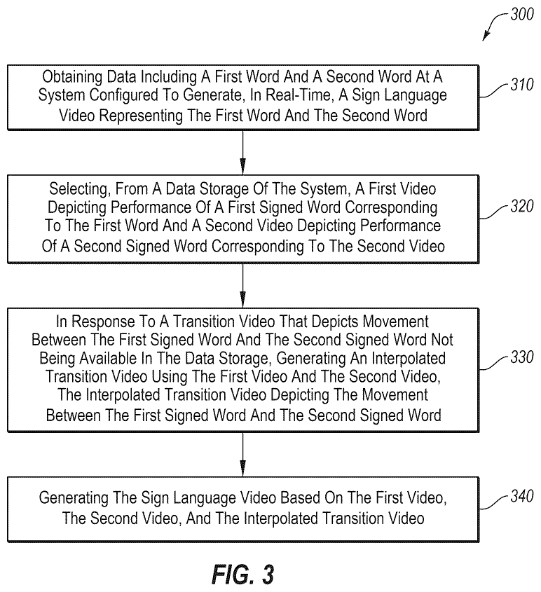

FIG. 3 illustrates a flowchart of an example method 300 of generating sign language, in accordance with one or more embodiments of the present disclosure. The method 300 may be performed by any suitable system, apparatus, or device. For example, the method 300 may be implemented using the environment 100 of FIG. 1 or the computing system 1000 of FIG. 10. Although illustrated with discrete blocks, the steps and operations associated with one or more blocks of the method 300 may be divided into additional blocks, combined into fewer blocks, or eliminated, depending on the particular implementation.

The method 300 of sign language generation may include blocks 310, 320, 330, and 340. At block 310, data may be obtained including a first word and a second word at a system configured to generate, in real-time, a sign language video representing the first word and the second word.

In some embodiments, the data may be obtained from audio obtained during a communication session that includes a first device and a second device, and the audio may originate at the second device. In these and other embodiments, the system may select, automatically and independently, a second translation process instead of a first translation process to translate the audio during the communication session. In these and other embodiments, the second translation process may cause the system to generate, in real-time, the sign language video representing the first word and the second word.

At block 320, a first video depicting performance of a first signed word corresponding to the first word and a second video depicting performance of a second signed word corresponding to the second word may be selected from a data storage.

In some embodiments, a first frame included in the first video may be obtained, and the first frame may depict a subject in a first position that corresponds to at least a portion of the first signed word. In some embodiments, the first frame may be one of the last three frames of the first video. In these and other embodiments, a first set of reference points may be obtained that corresponds to the subject in the first position.

In some embodiments, a second frame included in the second video may be obtained, and the second frame may depict the subject in a second position that corresponds to at least a portion of the second signed word. In some embodiments, the second frame may be one of the first three frames of the second video. In these and other embodiments, a second set of reference points may be obtained that corresponds to the subject in the second position.

At block 330, an interpolated transition video may be generated using the first video and the second video in response to a transition video that depicts movement between the first signed word and the second signed word not being available in the data storage. In these and other embodiments, the interpolated transition video may depict the movement between the first signed word and the second signed word.

In some embodiments, an interpolated transition frame corresponding to the subject in a third position that is between the first position and the second position may be generated. In these and other embodiments, the interpolated transition video may be generated using the interpolated transition frame.

In these and other embodiments, a set of interpolated reference points corresponding to the subject in the third position may be created. In these and other embodiments, the interpolated transition frame may be generated based on the set of interpolated reference points.

At block 340, the sign language video may be generated based on the first video, the second video, and the interpolated transition video.

Modifications, additions, or omissions may be made to the method 300 without departing from the scope of the disclosure. For example, the designations of different elements in the manner described is meant to help explain concepts described herein and is not limiting. Further, the method 300 may include any number of other elements or may be implemented within other systems or contexts than those described.

For example, in some embodiments, a GAN may generate the sign language video based on the first video, the second video, and the interpolated transition video. In some embodiments, the interpolated transition frame may be provided to the GAN, and the GAN may generate the interpolated transition video in response to being provided the interpolated transition frame. In some embodiments, the set of interpolated reference points may be provided to the GAN, and the GAN may generate the interpolated transition frame in response to being provided the set of interpolated reference points.

In some embodiments, the system may obtain additional data including a third word and a fourth word, and the system may be configured to generate, in real-time, a second sign language video representing the third word and the fourth word.

In these and other embodiments, a third video depicting performance of a third signed word corresponding to the third word, and a fourth video depicting performance of a fourth signed word corresponding to the fourth word may be selected from a data storage.

In these and other embodiments, a transition video may be obtained that depicts movement between the third signed word and the fourth signed word from the data storage. In these and other embodiments, the second sign language video may be generated based on the third video, the fourth video, and the transition video. For example, a second combined sign language video may be generated based on a third sign language video, a fourth sign language video, and the transition video.

FIG. 4 illustrates an operational workflow 400 for interpolation of movement between a first set of reference points 405 and a second set of reference points 410 to generate a set of interpolated reference points 460. The operational workflow 400 may be implemented by a system such as the interpolation system 146 of the communication system 130 described with respect to FIG. 1, and/or the computing system 1000 described with respect to FIG. 10. The first set of reference points 405 may be similar to the first set of reference points 206 described with reference to FIGS. 2A and 2B, and the second set of reference points 410 may be similar to the second set of reference points 208 described with reference to FIGS. 2A and 2B.

The first set of reference points 405 may correspond to an object in a first position, and the second set of reference points 410 may correspond to the object in a second position. In these and other embodiments, the first position may correspond to at least a portion of a first signed word, and/or the second position may correspond to at least a portion of a second signed word. As used in this disclosure, the term “object” may include a subject (e.g., the subject 202 of FIGS. 2A and 2B), an item, background, foreground, a prop, or any other object that may be obtained from an image.

The object may include one or more portions. In some embodiments, the portions may be connected to one another. In some embodiments, the object may include a first portion, a second portion, a third portion, and/or a fourth portion. In these and other embodiments, the first portion may be connected to the second portion and/or the third portion may be connected to the second portion. For example, a first end of the first portion may be connected to a second end of the second portion, and/or a third end of the second portion may be connected to a fourth end of the third portion. In some embodiments, the portions may not be connected to one another, but may be spatially related to one another such that the movement of one portion impacts the position another spatially related portion. For example, the fourth portion may not be connected to the first portion, the second portion, and/or the third portion, but may be spatially related to the first portion, the second portion, and/or the third portion such that the movement of the first portion, the second portion, and/or the third portion affects the fourth portion. In some embodiments, the object may be a subject having a body, such as the subject 202 described with respect to FIGS. 2A and 2B.

In some embodiments, movement of a portion of the object may cause other portions connected to that portion to move in response to the movement of that portion. For example, movement of the first portion may also cause the second portion and/or the third portion to move, and/or movement of the second portion may cause the third portion to move.

In some embodiments, each reference point in the first set of reference points 405 and/or each reference point in the second set of reference points 410 may correspond to a different location on the object. For example, the reference points in the first set of reference points 405 and the second set of reference points 410 may be numerical vectors having coordinates associated with various portions of the object.

In some embodiments, each reference point in the first set of reference points 405 may correspond to a portion of the object to which a reference point in the second set of reference points 410 also corresponds. For example, the object may have a reference point in the first set of reference points 405 that corresponds to the first portion in a first position, and the object may have a reference point in the second set of reference points 410 that also corresponds to the first portion, but in a second position. In some embodiments, each portion of the object may have a corresponding reference point in the first set of reference points 405, and/or each portion of the object may have a corresponding reference point in the second set of reference points 410. For example, a first reference point that corresponds to the first portion, a second reference point that corresponds to the second portion, a third reference point that corresponds to the third portion, and/or a fourth reference point that corresponds to the fourth portion may be included in the first set of reference points 405 and/or the second set of reference points 410. For instance, the first set of reference points 405 and/or the second set of reference points 410 may have one or more head reference points, one or more body reference points including a wrist reference point, one or more hand reference points, and/or one or more finger reference points as described in more detail with reference to FIGS. 5A and 5B. In some embodiments, the first set of reference points 405 may have the same number or a different number of reference points as the second set of reference points 410.

In some embodiments, the first set of reference points 405 and the second set of reference points 410 may be provided to a first interpolation algorithm 415. The first interpolation algorithm 415 may be executed by a combination of hardware, such as processors, communication units, memory, servers, databases, and data storage that are networked together and configured to perform one or more tasks. The first interpolation algorithm 415 may be configured to determine movement of a portion of the object as the portion of the object moves between a first position and a second position, where the first position is based on the first set of reference points 405 and the second position is based on the second set of reference points 410. In these and other embodiments, the first interpolation algorithm 415 may determine the movement of the portion of the object using the first set of reference points 405 and the second set of reference points 410. For example, the first interpolation algorithm 415 may determine movement of a wrist between a first position and a second position of the wrist as is discussed in more detail with reference to FIG. 5A.

In some embodiments, the first interpolation algorithm 415 may determine a first movement vector 420 based on the first set of reference points 405 and the second set of reference points 410. The first movement vector 420 may define the movement of the first portion of the object between the first set of reference points 405 and the second set of reference points 410. In these and other embodiments, the first movement vector 420 may be determined based on one or more reference points corresponding to the first portion in the first set of reference points 405 and one or more reference points corresponding to the first portion in the second set of reference points 410. In some embodiments, the first movement vector 420 may be a 2D vector or the first movement vector 420 may be a 3D vector. The first movement vector 420 may also impact the movement of the other portions of the object such as the second portion of the object, the third portion of the object, and/or the fourth portion of the object because the second portion, the third portion, and/or the fourth portion may be connected to the first portion.

In some embodiments, one or more first interpolated reference points 425 may be generated based on the first set of reference points 405, the second set of reference points 410, and/or the first movement vector 420. For example, the first movement vector 420 may be applied to a reference point in the first set of reference points 405 that corresponds to the first portion of the object to generate the first interpolated reference point 425. The first interpolated reference point 425 may correspond to a portion of the object in a third position that is between the first position of the object and the second position of the object. For example, the first interpolated reference point 425 may correspond to the first portion of the object at a third position that is between the first position and the second position of the object. In some embodiments, multiple interpolated reference points may be generated that correspond to the first portion at various positions between the first set of reference points 405 and the second set of reference points 410. The first interpolated reference point 425 may be similar to the interpolated reference points in the sets of interpolated reference points 212 described with respect to FIGS. 2A and 2B.

In some embodiments, the first interpolated reference point 425 may be a connection point between the first portion and the second portion of the object. For example, as is further described with reference to FIG. 5A, the first interpolated reference point 425 may correspond to a wrist.

In some embodiments, the first interpolation algorithm 415 may be implemented using forward kinematics interpolation algorithms. In these and other embodiments, the first interpolation algorithm 415 may use multiple reference points corresponding to the first portion of the object in the first set of reference points 405 and the second set of reference points 410 to determine how movement is propagated from a first end of the first portion to a second end of the first portion during movement of the object between the first position and the second position. Thus, the implementation of forward kinematics may allow the first interpolation algorithm 415 to account for how movement in a particular part of a portion of the object impacts movement in other parts of that portion and/or in other portions of the object. For example, as is described in more detail with reference to FIG. 5A, the first portion may include a shoulder joint, an elbow joint, and a wrist joint and movement about the shoulder joint may cause the position of the elbow joint and the wrist joint to change, and movement about the elbow joint may cause the position of the wrist joint to change. In addition, movement about the shoulder joint may cause the position of the hands and fingers to change.

After the first movement vector 420 and/or the first interpolated reference point 425 are determined, the first movement vector 420, the first interpolated reference point 425, the first set of reference points 405, and/or the second set of reference points 410 may be provided to a second interpolation algorithm 430. In some embodiments, the second interpolation algorithm 430 may be different than the first interpolation algorithm 415. For example, the second interpolation algorithm 430 may include a parallel translation and/or rotation interpolation algorithm.

The second interpolation algorithm 430 may be executed by a combination of hardware, such as processors, communication units, memory, servers, databases, and data storage that are networked together and configured to perform one or more tasks. The second interpolation algorithm 430 may be configured to determine movement of a portion of the object as the portion of the object moves between a first position and a second position, where the first position is based on the first set of reference points 405 and the second position is based on the second set of reference points 410. In these and other embodiments, the second interpolation algorithm 430 may determine the movement of the portion of the object using, the first set of reference points 405, the second set of reference points 410, the first movement vector 420, and/or the first interpolated reference point 425. For example, the second interpolation algorithm 430 may determine movement of a hand between a first position and a second position of the hand as is discussed in more detail with reference to FIG. 5A.

As discussed previously, movement of a portion of the object may affect the movement of other portions connected to that portion. For example, the movement of the first portion may impact the movement of the second portion. For instance, the first movement vector 420 and/or the first interpolated reference point 425 may affect the movement of the second portion of the object between the first position of the object and the second position of the object. Thus, in some embodiments, the second interpolation algorithm 430 may determine a second movement vector 435 based on the first set of reference points 405, the second set of reference points 410, the first movement vector 420, and/or the first interpolated reference point 425. The second movement vector 435 may define the movement of the second portion of the object between the first set of reference points 405 and the second set of reference points 410.

In these and other embodiments, the second movement vector 435 may be determined based on one or more reference points corresponding to the second portion in the first set of reference points 405 and one or more reference points corresponding to the second portion in the second set of reference points 410.

In these and other embodiments, the second movement vector 435 may be determined based on the first movement vector 420 and/or the first interpolated reference point 425. The first interpolated reference point 425, which may be generated based on the first movement vector 420, may correspond to the connection point between the first portion and the second portion, and, as a result, the first interpolated reference point 425 may impact the second movement vector 435 of the second portion of the object because the movement of the second portion may be partially dependent on the position of the first interpolated reference point 425.

For example, a first end of the first portion of the object may be coupled to a second end of the second portion of the object, and movement of the first portion may cause the first end of the first portion of the object to move, which may cause the second end of the second portion of the object to move. In these and other embodiments, the determination of the second movement vector 435 using the first movement vector 420 may include setting second movement vector values of the second movement vector 435 for the second end of the second portion of the object to first movement vector values of the first movement vector 420 for the first end of the first portion. For example, the second interpolation algorithm 430 may cause the second end of the second portion of the object to be connected to the first end of the first portion of the object during movement between the first position and the second position. Thus, in the third position, the second end of the second portion of the object may be connected to the first end of the first portion of the object at the first interpolated reference point 425.

In some embodiments, the second movement vector 435 may be a 2D vector or the second movement vector 435 may be a 3D vector. The second movement vector 435 may also impact the movement of other portions of the object such as the third portion of the object, and/or the fourth portion of the object because the third portion, and/or the fourth portion may be connected to the second portion.

In some embodiments, one or more second interpolated reference points 440 may be generated based on the first set of reference points 405, the second set of reference points 410, the first interpolated reference point 425, and/or the second movement vector 435. For example, the second movement vector 435 may be applied to a reference point in the first set of reference points 405 that corresponds to the second portion of the object to generate the second interpolated reference point 440. The second interpolated reference point 440 may correspond to a portion of the object in a third position that is between the first position of the object and the second position of the object. For example, the second interpolated reference point 440 may correspond to the second portion of the object at a third position that is between the first position and the second position of the object. In some embodiments, multiple interpolated reference points may be generated that correspond to the second portion at various positions between the first set of reference points 405 and the second set of reference points 410. The second interpolated reference point 440 may be similar to the interpolated reference points in the sets of interpolated reference points 212 described with respect to FIGS. 2A and 2B.

In some embodiments, the second interpolated reference point 440 may be a connection point between the second portion and the third portion of the object. For example, as is further described with reference to FIG. 5A, the second interpolated reference point 440 may correspond to a fist node of a hand.

In some embodiments, the second interpolation algorithm 430 may be implemented using parallel translation and/or rotation algorithms. In these and other embodiments, the second interpolation algorithm 430 may use multiple reference points corresponding to the second portion of the object in the first set of reference points 405 and the second set of reference points 410 to determine movement of the second portion between the first position and the second position without rotation. For example, the second interpolation algorithm 430 may use parallel translation to determine the movement of the reference points corresponding to the second portion in two-dimensional space or three-dimensional space. For instance, one or more reference points corresponding to the second portion may be translated in two-dimensional space or three-dimensional space based on the spatial relationship between the one or more reference points corresponding to the second portion and the one or more reference points corresponding to the first portion such that the spatial relationship may be maintained with respect to, for example, the first interpolated reference point 425.

In these and other embodiments, the second interpolation algorithm 430 may use multiple reference points corresponding to the second portion of the object in the first set of reference points 405 and the second set of reference points 410 to determine rotational movement of the second portion between the first set of reference points 405 and the second set of reference points 410. For example, the second interpolation algorithm 430 may determine the rotational movement of the reference points corresponding to the second portion about a point of rotation (e.g., a wrist joint). The movements determined by the second interpolation algorithm 430 from the parallel translation and/or rotation may be combined to determine the second movement vector 435, and the second movement vector 435 may be applied to a reference point corresponding to the second portion in, for example, the first set of reference points 405 to generate the second interpolated reference point 440.

After the second movement vector 435 and/or the second interpolated reference point 440 are determined, the second movement vector 435, the second interpolated reference point 440, the first set of reference points 405, and/or the second set of reference points 410 may be provided to a third interpolation algorithm 445. In some embodiments, the third interpolation algorithm 445 may be the same or different than the first interpolation algorithm 415 and/or the second interpolation algorithm 430. For example, the third interpolation algorithm 445 may be implemented using forward kinematics interpolation algorithms.

The third interpolation algorithm 445 may be executed by a combination of hardware, such as processors, communication units, memory, servers, databases, and data storage that are networked together and configured to perform one or more tasks. The third interpolation algorithm 445 may be configured to determine movement of a portion of the object as the portion of the object moves between a first position and a second position, where the first position is based on the first set of reference points 405 and the second position is based on the second set of reference points 410. In these and other embodiments, the third interpolation algorithm 445 may determine the movement of the portion of the object using the first set of reference points 405, the second set of reference points 410, the second movement vector 435, and/or the second interpolated reference point 440. For example, the third interpolation algorithm 445 may determine movement of fingers between a first position and a second position as is discussed in more detail with reference to FIG. 5A.

As discussed previously, movement of a portion of the object may affect the movement of other portions connected to that portion. For example, the movement of the second portion may impact the movement of the third portion. For instance, the second movement vector 435 and/or the second interpolated reference point 440 may affect the movement of the third portion of the object between the first position of the object and the second position of the object. Thus, in some embodiments, the third interpolation algorithm 445 may determine a third movement vector 450 based on the first set of reference points 405, the second set of reference points 410, the second movement vector 435, and/or the second interpolated reference point 440. The third movement vector 450 may define the movement of the third portion of the object between the first set of reference points 405 and the second set of reference points 410.

In these and other embodiments, the third movement vector 450 may be determined based on one or more reference points corresponding to the third portion in the first set of reference points 405 and one or more reference points corresponding to the third portion in the second set of reference points 410.

In these and other embodiments, the third movement vector 450 may be determined based on the second movement vector 435 and/or the second interpolated reference point 440. The second interpolated reference point 440, which may be generated based on the second movement vector 435, may correspond to the connection point between the second portion and the third portion, and, as a result, the second interpolated reference point 440 may impact the third movement vector 450 of the third portion of the object because the movement of the third portion may be partially dependent on the position of the second interpolated reference point 440.

For example, the third end of the second portion of the object may be coupled to the fourth end of the third portion of the object, and movement of the second portion may cause the third end of the second portion of the object to move, which may cause the fourth end of the third portion of the object to move. In these and other embodiments, the determination of the third movement vector 450 using the second movement vector 435 may include setting third movement vector values of the third movement vector 450 for the fourth end of the third portion to second movement vector values of the second movement vector 435 for the third end of the second portion. For example, the third interpolation algorithm 445 may cause the fourth end of the third portion of the object to be connected to the third end of the second portion of the object during movement between the first position and the second position. Thus, in the third position, the fourth end of the third portion of the object may be connected to the third end of the second portion of the object at the second interpolated reference point 440.

In some embodiments, the third movement vector 450 may be a 2D vector or the third movement vector 450 may be a 3D vector. The third movement vector 450 may also impact the movement of other portions of the object that are connected to the third portion.

In some embodiments, one or more third interpolated reference points 455 may be generated based on the first set of reference points 405, the second set of reference points 410, the second interpolated reference point 440, and/or the third movement vector 450. For example, the third movement vector 450 may be applied to a reference point in the first set of reference points 405 that corresponds to the third portion of the object to generate the third interpolated reference point 455. The third interpolated reference point 455 may correspond to a portion of the object in a third position that is between the first position of the object and the second position of the object. For example, the third interpolated reference point 455 may correspond to the third portion of the object at a third position that is between the first position and the second position of the object. In some embodiments, multiple interpolated reference points may be generated that correspond to the third portion at various positions between the first set of reference points 405 and the second set of reference points 410. The third interpolated reference point 455 may be similar to the interpolated reference points in the sets of interpolated reference points 212 described with respect to FIGS. 2A and 2B.

In some embodiments, the third interpolation algorithm 445 may be implemented using forward kinematics algorithms. In these and other embodiments, the implementation of the forward kinematics algorithms with respect to the third portion may be similar to as described previously with respect to the first portion. For example, as is described in more detail with reference to FIG. 5A, the third portion may include a finger with a base knuckle joint, a middle knuckle joint, and/or a tip joint, movement about the base knuckle joint may cause the position of the middle knuckle joint, and/or the tip joint to move, and movement about the middle knuckle joint may cause the position of the tip joint to move.

In some embodiments, a set of interpolated reference points 460 may be created that includes the first interpolated reference point 425, the second interpolated reference point 440, and/or the third interpolated reference point 455. The set of interpolated reference points 460 may correspond to the object in a third position that is between the first position of the object and the second position of the object. For example, the first interpolated reference point 425 may correspond to the first portion of the object in the third position, the second interpolated reference point 440 may correspond to the second portion of the object in the third position, and/or the third interpolated reference point 455 may correspond to the third portion of the object in the third position. In these and other embodiments, the third position may correspond to at least a portion of the movement between a first signed word and a second signed word.

The set of interpolated reference points 460 may be similar to the sets of interpolated reference points 212 described with respect to FIGS. 2A and 2B. For example, the set of interpolated reference points 460 may be used to generate an interpolated transition frame such as the transition frames 250 described with respect to FIG. 2.

Modifications, additions, or omissions may be made to the operational workflow 400 without departing from the scope of the present disclosure. For example, the first interpolation algorithm 415 and/or third interpolation algorithm 445 may utilize other motion analysis techniques in addition to or instead of forward kinematics, and/or the second interpolation algorithm 430 may utilize other motion analysis techniques in addition to or instead of parallel translation and/or rotation. Furthermore, in some embodiments, the object may have a higher number or lower number of portions than described and/or one or more of interpolation algorithms may be added or omitted.

Additionally, multiple sets of interpolated reference points 460 may be generated by the operational workflow 400. In these and other embodiments, each set of interpolated reference points 460 may correspond to a different position of the object between the first position and the second position.

In some embodiments, the first set of reference points 405 and the second set of reference points 410 may be provided to a fourth interpolation algorithm (not shown). The fourth algorithm may be executed by a combination of hardware, such as processors, communication units, memory, servers, databases, and data storage that are networked together and configured to perform one or more tasks. The fourth interpolation algorithm may be configured to determine movement of a portion of the object as the portion of the object moves between a first position and a second position, where the first position is based on the first set of reference points 405 and the second position is based on the second set of reference points 410. In these and other embodiments, the fourth interpolation algorithm may determine the movement of the portion of the object using the first set of reference points 405 and the second set of reference points 410. For example, the fourth interpolation algorithm may determine the movement of a head between a first position and a second position of the head as is discussed in more detail with reference to FIG. 5B.

In some embodiments, the fourth interpolation algorithm may determine a fourth movement vector based on the first set of reference points 405 and the second set of reference points 410. The fourth movement vector may define the movement of the fourth portion of the object between the first set of reference points 405 and the second set of reference points 410. In these and other embodiments, the fourth movement vector may be determined based on one or more reference points corresponding to the fourth portion in the first set of reference points 405 and one or more reference points corresponding to the fourth portion in the second set of reference points 410. In some embodiments, the fourth movement vector may be a 2D vector or the fourth movement vector may be a 3D vector.

In some embodiments, a fourth interpolated reference point may be generated based on the first set of reference points 405, the second set of reference points 410, and/or the fourth movement vector. For example, the fourth movement vector may be applied to a reference point in the first set of reference points 405 that corresponds to the fourth portion of the object to generate the fourth interpolated reference point. The fourth interpolated reference point may correspond to a portion of the object in a third position that is between the first position of the object and the second position of the object. For example, the fourth interpolated reference point may correspond to the fourth portion of the object at a third position that is between the first position and the second position of the object. In some embodiments, multiple interpolated reference points may be generated that correspond to the fourth portion at various positions between the first set of reference points 405 and the second set of reference points 410. The fourth interpolated reference point may be similar to the interpolated reference points in the sets of interpolated reference points 212 described with respect to FIGS. 2A and 2B.

In some embodiments, the fourth interpolation algorithm may be implemented using linear interpolation. In these and other embodiments, the fourth interpolation algorithm may use multiple reference points corresponding to the fourth portion of the object in the first set of reference points 405 and the second set of reference points 410 to determine one or more fourth interpolated reference points. For example, as is described in more detail with reference to FIG. 5B, the fourth portion may include a head and movement of the head between a first position and a second position of the head may be determined utilizing linear interpolation.

FIGS. 5A and 5B illustrate an example interpolation process 500 used to generate an interpolated transition video 550 of a subject 502 that may depict movement between a first sign language video (not shown) depicting performance of a first signed word and a second sign language video (not shown) depicting performance of a second signed word. The example interpolation process 500 may be implemented by a system such as the interpolation system 146 of the communication system 130 described with respect to FIG. 1, and/or the computing system 1000 described with respect to FIG. 10. The example interpolation process 500 may also be implemented by the operational workflow 400 described with respect to FIG. 4.

The first sign language video, the second sign language video, the subject 502, and the interpolated transition video 550 may be similar to similarly named elements described throughout this disclosure. For example, the subject 502 may be similar to the subject 202, the first sign language video may be similar to the first sign language video 200, the second sign language video may be similar to the second sign language video 220, and the interpolated transition video 550 may be similar to the transition video 240, all described with respect to FIGS. 2A and 2B.

The example interpolation process 500 may determine a position of the subject 502 between a first set of reference points that may correspond to the subject 502 in a first position and a second set of reference points that may correspond to the subject 502 in a second position. The first set of reference points and the second set of reference points may be obtained as described throughout the disclosure.

As illustrated in FIG. 5B, the first set of reference points and the second set of reference points may be used by the example interpolation process 500 to generate sets of interpolated reference points 562 and corresponding interpolated transition frames 560 of the subject 502 in a position that may be between the first position of the subject 502 and the second position of the subject 502. The interpolated transition frames 560 may be similar to the transition frames 250 described with respect to FIG. 2B. For example, a first interpolated transition frame 560a may correspond to a first interpolated position of the subject 502 defined by a first set of interpolated reference points 562a, a second interpolated transition frame 560a may correspond to a second interpolated position of the subject 502 defined by a second set of interpolated reference points 562b, a third interpolated transition frame 560c may correspond to a third interpolated position of the subject 502 defined by a third set of interpolated reference points 562c, a fourth interpolated transition frame 560d may correspond to a fourth interpolated position of the subject 502 defined by a fourth set of interpolated reference points 562d, a fifth interpolated transition frame 560e may correspond to a fifth interpolated position of the subject 502 defined by a fifth set of interpolated reference points 562e, and/or a sixth interpolated transition frame 560f may correspond to a sixth interpolated position of the subject 502 defined by a sixth set of interpolated reference points 562f.

As illustrated in FIGS. 5A and 5B, the subject 502 may include a first portion 510, a second portion 520, a third portion 530, and fourth portion 540, similar to the subject 202 described with respect to FIGS. 2A and 2B and the object described with respect to FIG. 4. For example, the first portion 510, the second portion 520, the third portion 530, and the fourth portion 540 may be connected in a similar manner as the portions of the subject 202 described with respect to FIGS. 2A and 2B and the object described with respect to FIG. 4.

The first portion 510 may be illustrated in multiple different positions in first views 516a-516f, where each view is a different position of the first portion 510 in a different stage of interpolation of the movement of the first portion 510 between the first and second positions of the subject 502. Similarly, the second portion 520 is illustrated in multiple different positions in second views 526a-526f, the third portion 530 is illustrated in multiple different positions in third views 536a-536f, and the fourth portion 540 is illustrated in multiple different positions in fourth views 546a-546f.

In some embodiments, the first portion 510 may have a corresponding first interpolated reference point 512 that may be associated with a shoulder joint, an elbow joint, and a wrist joint.

For example, the first interpolated reference points 512 may include interpolated wrist reference points 514. For instance, a first interpolated wrist reference point 514a, a second interpolated wrist reference point 514b, a third interpolated wrist reference point 514c, a fourth interpolated wrist reference point 514d, a fifth interpolated wrist reference point 514e, and/or a sixth interpolated wrist reference point 514f may correspond to various stages of interpolation of a wrist of the subject 502 between the first and second positions of the subject 502. In some embodiments, and as illustrated in FIG. 5A, the one or more first interpolated reference points 512 may include interpolated shoulder reference points and/or interpolated elbow reference points.

The interpolated wrist reference points 514 may be generated based on a first interpolation algorithm such as the first interpolation algorithm 415 described with respect to FIG. 4. As described previously, the interpolated wrist reference points 514 may be generated based on a first movement vector (e.g., the first movement vector 420) that may be determined via the first interpolation algorithm. The first movement vector may define a movement of the first portion 510 between the first set of reference points and the second set of reference points.

For example, the interpolated wrist reference points 514 may be generated using forward kinematics. In these and other embodiments, the interpolated wrist reference points 514 may be generated based on the movement about the shoulder joints and/or the movement about the elbow joints between the first and the second positions. In these and other embodiments, the movement (e.g., movement vectors) may be accumulated from the shoulder joint to the elbow joint to the wrist joint such that the interpolated wrist reference points 514 may be determined from the accumulated movement.

The movement about the shoulder between the first position and the second position may be determined first. The movement about the shoulder joint may cause an upper arm connected to the shoulder joint, an elbow joint connected to the upper arm, a forearm connected to the elbow joint, and a wrist joint connected to the forearm to move. For example, a first angle of the upper arm relative to the shoulder joint may change as the subject 502 moves. For instance, as illustrated in FIG. 5A, the angle of the left upper arm relative to the left shoulder and the angle of the right upper arm relative to the right shoulder changes as the subject 502 moves between the first and the second position. As the first angle of the upper arm relative to the shoulder joint changes and the upper arm moves, the elbow joint may also move. Thus, the position of the elbow may be determined based on the movement about the shoulder. In some embodiments, an interpolated elbow reference point may be generated based on the movement about the shoulder. For example, coordinates for an interpolated elbow reference point may be generated based on the movement about the shoulder between the first set of reference points and the second set of reference points.

The movement about the elbow joint between the first position and the second position may be determined second. The movement about the elbow joint may cause the forearm and the wrist joint to move. For example, a second angle of the forearm relative to the elbow joint may change as the subject 502 moves between the first and the second positions. For instance, as illustrated in FIG. 5A, the second angle of the left forearm relative to the left elbow and the second angle of the right forearm relative to the right elbow changes as the subject 502 moves. As the second angle of the forearm relative to the elbow joint changes and the forearm moves, the wrist joint may also move. Thus, the movement of the wrist joint may be determined based on the movement about the elbow joint.

For example, the first movement vector of the wrist joint may be determined based on the movement vector of the upper arm about the shoulder joint and the movement vector of the lower arm about the elbow joint. Thus, the movement vector for the wrist joint may be determined by accumulating the movement down the arm starting at the shoulder joint and ending at the wrist joint.

In some embodiments, the interpolated wrist reference points 514 may be determined based on the movement about the elbow joint, which may also take into account the movement about the shoulder joint. For example, coordinates for the interpolated wrist reference points 514 may be determined based on the movement about the elbow joint and the shoulder joint between the first set of reference points and the second set of reference points.

In some embodiments, one or more second interpolated reference points 522 may correspond to the second portion 520. In some embodiments, the second portion 520 may include a hand, and the second interpolated reference points 522 may be associated with various parts of the hand. For example, the second portion 520 may have a corresponding second interpolated reference point 522 that may be associated with the palm, the dorsal side of the hand, and/or one or more fist nodes.

For example, the second interpolated reference points 522 may include interpolated hand reference points 524. For instance, a first interpolated hand reference point 524a, a second interpolated hand reference point 524b, a third interpolated hand reference point 524c, a fourth interpolated hand reference point 524d, a fifth interpolated hand reference point 524e, and/or a sixth interpolated hand reference point 524f may correspond to various stages of interpolation of a hand of the subject 502 between the first and second positions of the subject 502.

The interpolated hand reference points 524 may be generated based on a second interpolation algorithm such as the second interpolation algorithm 430 described with respect to FIG. 4. As described previously, the second interpolation algorithm may generate the interpolated hand reference points 524 based on a second movement vector (e.g., the second movement vector 435) that defines a movement of the second portion 520 between the first set of reference points and the second set of reference points and based on the interpolated wrist reference points 514.

In some embodiments, the second portion 520 may be connected to the first portion 510. For example, a first end (e.g., the wrist) of the first portion 510 may be coupled to a second end of the second portion 520 (e.g., a base of the hand). In these and other embodiments, the second end and the first end may have the same movement vector, which may have already been determined by the first interpolation algorithm. Thus, the hand movement vector values at the end of the hand that connects to the wrist may be set to the wrist movement vector values. For instance, the hand movement vector values at the end of the hand that connects to the wrist may be set to the wrist movement vector values of the interpolated wrist reference points 514 at each interpolated position.

In some embodiments, the interpolated hand reference points 524 may be generated using parallel translation and/or rotation. The second interpolation algorithm may utilize parallel translation to translate the reference points corresponding to the hand from the first set of reference points to the second set of reference points, and the interpolated positions in between. As previously discussed, the movement vectors for the wrist, and/or the interpolated wrist reference points 514 may already be determined based on the first interpolation algorithm. Accordingly, in some embodiments, reference points in the first set of reference points corresponding to the hand and/or fingers may be translated in parallel according to the spatial relationships of the hand and/or fingers relative to the wrist such that the interpolated hand reference points 524 and/or interpolated finger reference points 534 may maintain the spatial relationship of the hand and/or fingers at each interpolated position.

For example, the interpolation process 500 may determine a spatial relationship of the reference points corresponding to the hand in the first and/or second set of reference points relative to the reference points corresponding to the wrist in the first set and/or second set of reference points. The example interpolation process 500 may use the spatial relationship of the hand reference points and the wrist reference points in the first and/or second sets of reference points and the position of the interpolated wrist reference points 514 to determine the interpolated hand reference points 524. For example, because the spatial relationship between the hand reference points and the wrist reference points in the first and/or second set of reference points may be known, and the position of the interpolated wrist reference points 514 may be known after applying the first interpolation algorithm, the spatial relationship may be applied relative to the interpolated wrist reference points 514 to generate the interpolated hand reference points 524.

In these and other embodiments, rotation may be used by the second interpolation algorithm to generate the interpolated hand reference points 524. For example, a rotational movement vector of the second portion 520 about the first portion 510 may be determined, and the position of the interpolated hand reference points 524 may be determined based on the rotational movement vector of the second portion 520. For instance, as illustrated in FIG. 5A, the hand may rotate about the wrist, and a rotational movement vector of the hand about the wrist may be determined to generate the interpolated hand reference points 524.

In general, rotation of an object in three-dimensional space may be achieved in multiple directions (e.g., counterclockwise and clockwise). However, the direction of rotation of the hand about the wrist may be limited. For example, a human hand may not rotate 360 degrees about the wrist. To help in ensuring that the first portion 510 may be rotated about the second portion 520 in a manner that appears natural, a first plane may be defined using the first portion 510, a second plane may be defined using the second portion 520, and the normal vectors of each plane may be determined. Using the normal vectors of each plane, the second portion 520 may be oriented properly in relation to the first portion 510 and other parts of the subject. For example, the normal vectors may be positioned in relation to each other and the subject 502. In these and other embodiments, a first of the normal vectors may be positioned in relation to the subject 502 and a second of the normal vectors may be positioned in relation to the first normal vector. For example, one of the normal vectors may be positioned to be towards the subject 502 and another may be positioned at another angle with respect to the one normal vector. In these and other embodiments, the angle between the normal vectors may be less than a threshold. An amount of the threshold may depend on an anatomical relationship between the first portion 510 and the second portion 520. In these and other embodiments, the angle between the normal vectors may also be minimized.

For example, the direction of rotation of the second portion 520 may be based on a first normal vector to a first plane defined by the shoulder, the elbow, and the wrist of the first portion 510 and based on a second normal vector to a second plane defined by the palm of the second portion 520. The first normal vector may have two possible directions, one pointing toward the subject 502 and one pointing away from the subject 502. The second normal vector may also have two possible normal directions, one pointing outwardly from the palm and one pointing inwardly towards the palm. Using the wrong first normal vector direction and/or second normal vector direction, may result in a hand that is backwards, contorted, and/or that appears unnatural in the interpolated transition video 550.

In some instances, for the hand to appear to move naturally relative to the wrist, an angle between the first normal vector and the second normal vector may not exceed a threshold. The threshold may be between 180 and 220 degrees or some other number of degrees. Thus, in some embodiments, the interpolation process 500 may define the directions of the first and the second normal vectors such that the angle between the first and second normal vectors does not exceed 200 degrees. For example, the interpolation process 500 may select the minimum angle possible between the first and the second normal vectors.

In some embodiments, the right-hand rule may be utilized to determine the proper direction of the first normal vector and the second normal vector. For example, the right-hand rule may be used when the first plane is defined by the right shoulder, the right elbow, and the right wrist, and the second plane is defined by the right palm. In some embodiments, the left-hand rule may be utilized to determine the proper direction of the first normal vector and the second normal vector. For example, the left-hand rule may be used when the first plane is defined by the left shoulder, the left elbow, and the left wrist, and the second plane is defined by the left palm. Determining the proper direction of the first normal vector and the second normal vector may ensure that the palm is oriented correctly in relation to the shoulders, elbows, and wrist such that the hand may move in a manner that appears to be natural.

Thus, the direction of the first normal vector may be defined such that the direction of the first normal vector points towards the subject 502. The direction of the second normal vector may be defined such that the second normal vector points outwardly from the palm. As a result, regardless of how the first portion 510 and the second portion 520 of the subject 502 move, the angle between the first normal vector and the second normal vector may not exceed the threshold (e.g., 200 degrees). Consequently, when interpolating the movement of the second portion 520 between the first position and the second position, the hand may move in a manner that appears to be natural relative to the wrist.

The second movement vector may be determined by combining the movement determined by the parallel translation of the second portion 520 and/or the movement determined by the rotation of the second portion 520 about the interpolated wrist reference points 514. The interpolated hand reference points 524 may be generated at various positions between the first position and the second position based on the second movement vector and/or the interpolated wrist reference points 514.

In some embodiments, as illustrated in FIG. 5A, the third portion 530 may be kept invariant by the second algorithm meaning that the third portion 530 (e.g., the fingers) attached to the second portion 520 may be translated and/or rotated along with the second portion 520, but may otherwise be kept static (e.g., there may be no additional movement of the finger joints).

In some embodiments, one or more third interpolated reference points 532 may correspond to the third portion 530. In some embodiments, the third portion 530 may include fingers, and the third interpolated reference points 532 may be associated with various parts of the fingers. For example, the third portion 530 may have a corresponding third interpolated reference point 532 that may be associated with a base knuckle joint, a middle knuckle joint, and/or a tip joint.

For example, interpolated finger reference points 534 may correspond to the third portion 530. For instance, a first interpolated finger reference point 534a, a second interpolated finger reference point 534b, a third interpolated finger reference point 534c, a fourth interpolated finger reference point 534d, a fifth interpolated finger reference point 534e, and/or a sixth interpolated finger reference point 534f may correspond to various stages of interpolation of a finger of the subject 502 between the first and second positions of the subject 502. In some embodiments, the interpolated finger reference points 534 may include a corresponding finger reference point for each base knuckle joint, middle knuckle joint, and/or tip joint of each finger.

The interpolated finger reference points 534 may be generated based on a third interpolation algorithm such as the third interpolation algorithm 445 described with respect to FIG. 4. As described previously, the interpolated finger reference points 534 may be generated based on a third movement vector (e.g., the third movement vector 450) that defines a movement of the third portion 530 between the first set of reference points and the second set of reference points and based on the interpolated hand reference points 524.

In some embodiments, the third portion 530 may be connected to the second portion 520. For example, the third end (e.g., a fist node) of the second portion 520 may be coupled to the fourth end of the third portion 530 (e.g., the base knuckle joint). In these and other embodiments, the third end and the fourth end may have the same movement vector, which may have already been determined by the second interpolation algorithm. Thus, the finger movement vector values at the base of the fingers may be set to the hand movement vector values at the fist nodes (e.g., where the fingers connect to the hand). For example, a finger of the third portion 530 may have a base knuckle joint, a middle knuckle joint, and a tip joint, the base knuckle joint may be connected to a fist node of the second portion 520, and the finger movement vector values of the base knuckle joint may be set to the hand movement vector values at the fist node. For instance, the finger movement vector values at the base knuckle joint may be set to hand movement vector values of the interpolated hand reference points 524 at each interpolated position.

In some embodiments, the interpolated finger reference points 534 may be generated using forward kinematics. In these and other embodiments, the interpolated finger reference points 534 may be generated based on the movement about the base knuckle joint, the middle knuckle joint, and/or the tip joint. In these and other embodiments, the movement (e.g., movement vectors) may be accumulated from the base knuckle joint to the middle knuckle joint to the tip joint such that the interpolated finger reference points 534 may be generated according to the accumulated movement depending on where the interpolated finger reference points 534 are positioned on the finger. For example, the middle knuckle joint may accumulate the movement about the base knuckle joint, the tip joint may accumulate the movement about the base knuckle joint and/or the middle knuckle joint, and a tip of the finger may accumulate the movement about the base knuckle joint, the middle knuckle joint, and/or the tip joint. The movement and position between the base knuckle joint, the middle knuckle joint, and/or the tip joint may occur in a similar manner as the discussion of movement and position between the shoulder, elbow, and wrist.

Thus, the interpolated finger reference points 534 may be determined based on the movement about the base knuckle joint, the middle knuckle joint, and/or the tip joint, which may also take into account the movement about the shoulder joint, the elbow joint, the wrist joint, the palm, and/or others. For example, coordinates for the interpolated finger reference points 534 may be determined based on the movement about the base knuckle joint, the middle knuckle joint, and/or the tip joint between the first set of reference points and the second set of reference points.

In general, movement of the thumb in relation to the hand may be different than the pointer finger, the middle finger, the index finger, and/or the pinky finger. For example, the thumb may be more flexible than the other fingers attached to the hand meaning that the thumb may have a greater range of motion than the other fingers. Furthermore, the thumb may not be in the same plane as the other fingers. To help ensure that the third portion 530 may be moved about the second portion 520 in a manner that appears natural, the second plane may be defined using the second portion 520, a third plane may be defined using the third portion 530, and the normal vectors of each plane may be determined. Using the normal vectors of each plane, the third portion 530 may be oriented properly in relation to the second portion 520 and other parts of the subject 502. The normal vectors of the second plane and the third plane may be used in a similar manner as described previously with respect to the first plane and the second plane. For example, one of the normal vectors may be positioned to be towards the subject 502 and another may be positioned at another angle with respect to the one normal vector. In these and other embodiments, the angle between the normal vectors of the second plane and the third plane may be less than a threshold. An amount of the threshold may depend on an anatomical relationship between the second portion 520 and the third portion 530. In these and other embodiments, the angle between the normal vectors of the second plane and the third plane may also be minimized.

For example, the direction of movement of the third portion 530 may be based on the second normal vector to the second plane defined by the palm of the second portion 520 and based on a third normal vector to a third plane defined by the thumb of the third portion 530. As mentioned previously, the second normal vector may have two possible directions, one pointing outwardly from the palm and one pointing inwardly towards the palm. The third normal vector may also have two possible directions, one pointing outwardly from the thumb (e.g., towards the palm) and one point inwardly towards the thumb (e.g., away from the palm). Using the wrong second normal vector direction and/or third normal vector direction, may result in a thumb that is backwards, contorted, and/or that appears to move unnaturally relative to the hand in the interpolated transition video 550.

In some instances, for the thumb to appear to move naturally relative to the hand, an angle between the second normal vector and the third normal vector may not exceed a threshold. The threshold may be between 90 and 130 degrees or some other number of degrees. Thus, in some embodiments, the interpolation process 500 may define the directions of the second and the third normal vectors such that the angle between the second and third normal vectors does not exceed 110 degrees. For example, the interpolation process 500 may select the minimum angle possible between the second and third normal vectors.

In some embodiments, the right-hand rule may be utilized to determine the proper direction of the second normal vector and the third normal vector. For example, the right hand rule may be used when the second plane is defined by the right palm, and the third plane is defined by the right thumb. In some embodiments, the left-hand rule may be utilized to determine the proper direction of the second normal vector and the third normal vector. For example, the left-hand rule may be used when the second plane is defined by the left palm, and the third plane is defined by the left thumb. Determining the proper direction of the second normal vector and the third normal vector may ensure that the thumb is oriented correctly in relation to the palm such that the thumb may move in a manner that appears to be natural.

Thus, the direction of the third normal vector may be defined such that the third normal vector points in the direction of the palm. As discussed previously, the direction of the second normal vector may be defined such that the second normal vector points outwardly from the palm.

As a result, even though there may theoretically be multiple ways to move the thumb about the palm as the thumb moves between the first position and the second position, the angle between the second normal vector and the third normal vector may be controlled during the interpolation process 500 such that the angle between the second normal vector and the third normal vector does not exceed a threshold (e.g., 110 degrees). Consequently, the thumb may appear to move naturally in the interpolated transition video 550.

As illustrated in FIG. 5B, in some embodiments, one or more fourth interpolated reference points 542 may correspond to the fourth portion 540. In some embodiments, the fourth portion 540 may include a head, and the fourth interpolated reference points 542 may be associated with various parts of the head. For example, the fourth portion 540 may have a corresponding fourth interpolated reference point 542 that may be associated with an eye, an ear, a nose, a mouth, the forehead, the cheeks, the chin, other facial features, or along the boundary of the head.

For example, interpolated head reference points 544 may correspond to the fourth portion 540. For instance, a first interpolated head reference point 544a, a second interpolated head reference point 544b, a third interpolated head reference point 544c, a fourth interpolated head reference point 544d, a fifth interpolated head reference point 544e, and/or a sixth interpolated head reference point 544f may correspond to various stages of interpolation of the head of the subject 502 between the first and second positions of the subject 502. In some embodiments, the interpolated head reference points 544 may include a corresponding head reference point for the eyes, the ears, the mouth, and/or the nose of the subject 502.

The interpolated head reference points 544 may be generated via a fourth interpolation algorithm such as the fourth interpolation algorithm described with respect to FIG. 4. As described previously, the fourth interpolation algorithm may generate the interpolated head reference points 544 based on a fourth movement vector that defines a movement of the fourth portion 540 between the first set of reference points and the second set of reference points.

In some embodiments, the fourth portion 540 may not be connected to the first portion 510, the second portion 520, and/or the third portion 530. In some embodiments, the fourth portion 540 may be connected to another portion, but may not be influenced by the movement of the other portions.

In some embodiments, the interpolated head reference points 544 may be generated using linear interpolation. For example, the fourth interpolation algorithm may use linear interpolation to determine the fourth movement vector and/or generate the interpolated head reference points 544 for the fourth portion 540 of the subject.

In some embodiments, linear interpolation may use coordinates of a reference point corresponding to the fourth portion 540 of the subject 502 in the first set of reference points and coordinates of a reference point corresponding to the fourth portion 540 of the object in the second set of reference points to determine coordinates of, for example, the interpolated head reference points 544.

In some embodiments, the first interpolated reference points 512, the second interpolated reference points 522, the third interpolated reference points 532, and/or the fourth interpolated reference points 542 may be used to create the sets of interpolated reference points 562. For example, the interpolated wrist reference points 514, the interpolated hand reference points 524, the interpolated finger reference points 534, and/or the interpolated head reference points 544 may be combined to create the sets of interpolated reference points 562.

In some embodiments, the movement vectors of the first portion 510, the second portion 520, the third portion 530, and/or the fourth portion 540 may be combined in two-dimensional and/or three-dimensional space to generate the sets of interpolated reference points 562. For example, the movement vectors of the first portion 510, the second portion 520, the third portion 530, and/or the fourth portion 540 may be combined using vector addition.

Each set of interpolated reference points 562 may correspond to a respective interpolated transition frame 560. For example, the sets of interpolated reference points 562a-562f may respectively correspond to the interpolated transition frames 560a-560f. The interpolated transition frames 560 may be combined to generate the interpolated transition video 550 as described with reference to FIG. 1-3. Furthermore, a combined sign language video may be generated based on the interpolated transition video 550, the first sign language video depicting performance of the first signed word, and the second sign language video depicting performance of the second signed word as described with reference to FIGS. 1-3.

Modifications, additions, or omissions may be made to the example interpolation process 500 without departing from the scope of the disclosure. For example, a lower number or a higher number of interpolated reference points may be generated for the first portion 510, the second portion 520, the third portion 530, and/or the fourth portion 540. Furthermore, the positions of the interpolated reference points may differ from what is illustrated in FIGS. 5A and 5B.

Additionally, a higher number or lower number of portions may be included. For example, the first portion 510 may be broken up into additional portions. For example, the torso may be a portion and the shoulder, elbow, and wrist may makeup another portion.

Furthermore, the first interpolation algorithm and/or third interpolation algorithm may utilize other motion analysis techniques in addition to or instead of forward kinematics, the second interpolation algorithm may utilize other motion analysis techniques in addition to or instead of parallel translation and/or rotation, and/or the fourth interpolation algorithm may utilize other motion analysis techniques in addition to or instead of linear interpolation.

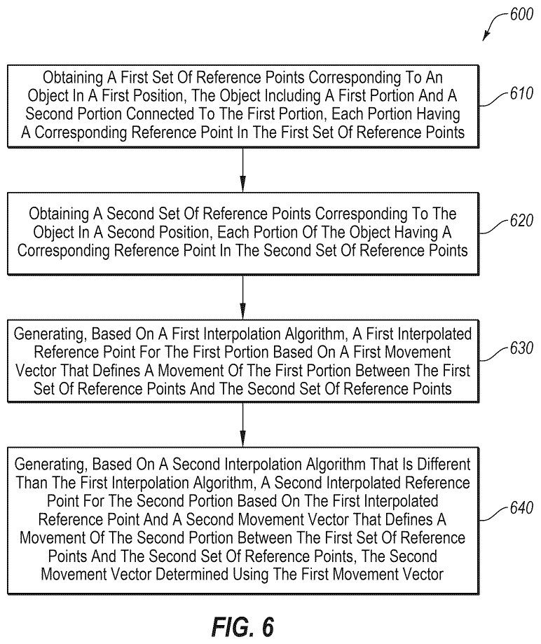

FIG. 6 illustrates a flowchart of an example method 600 of interpolation, in accordance with one or more embodiments of the present disclosure. The method 600 may be performed by any suitable system, apparatus, or device. For example, the method 600 may be implemented using the environment 100 of FIG. 1 or the computing system 1000 of FIG. 10. The method 600 may be implemented as part of the operational workflow 400 described with respect to FIG. 4 and/or the interpolation process 500 described with respect to FIGS. 5A and 5B. Although illustrated with discrete blocks, the steps and operations associated with one or more blocks of the method 600 may be divided into additional blocks, combined into fewer blocks, or eliminated, depending on the particular implementation.

The method 600 of interpolation may include blocks 610, 620, 630, and 640. At block 610, a first set of reference points corresponding to an object in a first position may be obtained. The object may include a first portion and a second portion connected to the first portion, and each portion may have a corresponding reference point in the first set of reference points.

At block 620, a second set of reference points corresponding to the object in a second position may be obtained. The first portion and the second portion of the object may have a corresponding reference point in the second set of reference points.

At block 630, based on a first interpolation algorithm, a first interpolated reference point for the first portion may be generated based on a first movement vector that defines a movement of the first portion between the first set of reference points and the second set of reference points.

In some embodiments, the first movement vector may be determined, via the first interpolation algorithm, from the corresponding reference point of the first portion in the first set of reference points to the corresponding reference point of the first portion in the second set of reference points.

At block 640, based on a second interpolation algorithm that is different than the first interpolation algorithm, a second interpolated reference point for the second portion may be generated based on the first interpolated reference point and a second movement vector that defines a movement of the second portion between the first set of reference points and the second set of reference points. The second movement vector may be determined using the first movement vector.

In some embodiments, the second movement vector may be determined, via the second interpolation algorithm, from the corresponding reference point of the second portion in the first set of reference points to the corresponding reference point of the second portion in the second set of reference points. In these and other embodiments, the second movement vector may be based on the first movement vector.

Modifications, additions, or omissions may be made to the method 600 without departing from the scope of the disclosure. For example, the designations of different elements in the manner described is meant to help explain concepts described herein and is not limiting. Further, the method 600 may include any number of other elements or may be implemented within other systems or contexts than those described.

In some embodiments, the object may further include a third portion, and the third portion may have a corresponding reference point in the first set of reference points and the second set of reference points. In these and other embodiments, based on a third interpolation algorithm that is different than the second interpolation algorithm, a third interpolated reference point for the third portion may be generated based on the second interpolated reference point and a third movement vector that defines a movement of the third portion between the first set of reference points and the second set of reference points. The third movement vector may be determined using the second movement vector.

In some embodiments, a set of interpolated reference points including the first interpolated reference point, the second interpolated reference point, and/or the third interpolated reference point may be created. The set of interpolated reference points may correspond to the object in a third position that is between the first position and the second position.

In these and other embodiments, the third movement vector may be determined, via the third interpolation algorithm, from the corresponding reference point of the third portion in the first set of reference points to the corresponding reference point of the third portion in the second set of reference points. In these and other embodiments, the third movement vector may be based on the second movement vector.

In some embodiments, the object may include a body, the first portion may include a wrist, the second portion may include a hand, and/or the third portion may include a finger. In some embodiments, the first position may correspond to at least a portion of a first signed word and the second position may correspond to at least a portion of a second signed word.

In some embodiments, the first interpolation algorithm may utilize forward kinematics to determine the first movement vector, the second interpolation algorithm may utilize parallel translation and rotation to determine the second movement vector, and the third interpolation algorithm may utilize forward kinematics to determine the third movement vector.

In some embodiments, a first end of the first portion of the object may be coupled to a second end of the second portion of the object, and the determination of the second movement vector using the first movement vector may include setting second movement vector values of the second movement vector for the second end of the second portion of the object to first movement vector values of the first movement vector for the first end of the first portion.

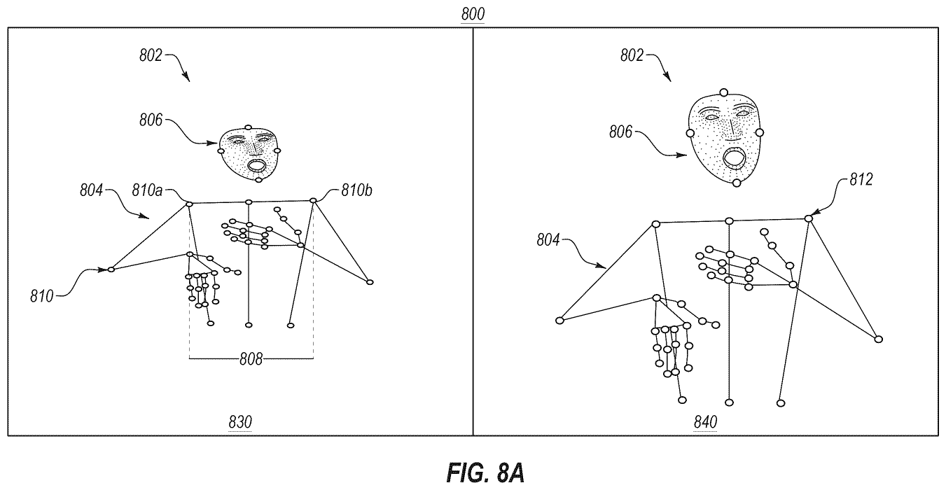

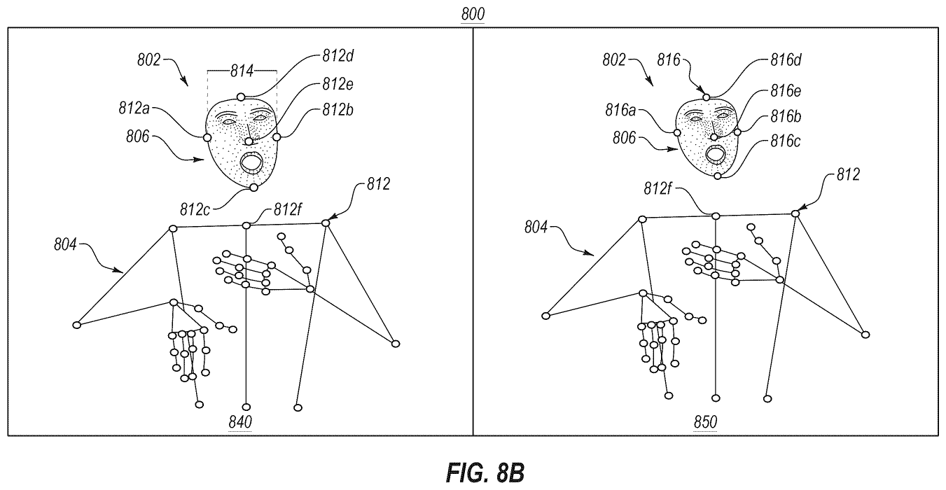

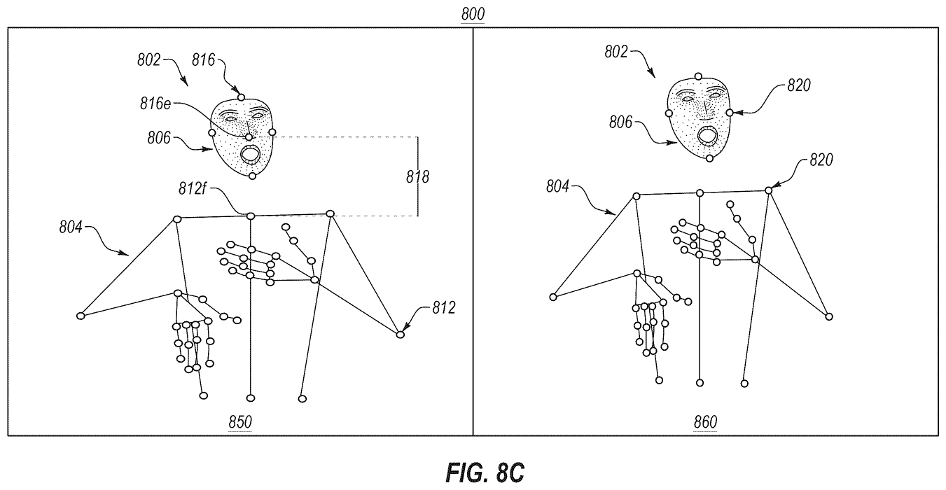

FIG. 7 illustrates an operational workflow 700 for normalizing a set of reference points 705 in an image. The operational workflow 700 may be implemented by a system such as the normalization system 148 of the communication system 130 described with respect to FIG. 1, and/or the computing system 1000 described with respect to FIG. 10. The set of reference points 705 may be similar to the reference points described throughout this disclosure. For example, the set of reference points 705 may be similar to the first set of reference points 206, the second set of reference points 208, and/or the set of interpolated reference points 212 described with respect to FIGS. 2A and 2B. FIG. 8A-8C illustrate an example implementation 800 of the operational workflow 700 and will be described in conjunction with FIG. 7.

As noted previously, the set of reference points 705 may be obtained from an image such that the set of reference points 705 may cause the image to appear to have one or more different image parameters than a second image. As a result, rendering artifacts may be present when the image and the second image are combined. Thus, the operational workflow 700 may be used to modify an image such that the image and the second image may be combined with a reduced number of rendering artifacts and/or a reduced severity of rendering artifacts. For example, as illustrated in FIG. 8A, the operational workflow 700 may be used to modify an image 830 that may show an object 802 that appears to be compressed and/or far away from the camera, which may appear unnatural to a viewer of the image 830.

Furthermore, in some embodiments, the second image may depict a different object than the object in the image. For example, the image may be obtained from a first sign language video depicting a first subject performing a first signed word, and the second image may be obtained from a second sign language video depicting a different, second subject performing a second signed word. In these and other embodiments, a first skeleton obtained based on the first sign language video may be sized, shaped, proportioned, or otherwise dimensioned differently than a second skeleton obtained based on the second sign language video.

In some embodiments, the details of the second subject may be used in conjunction with the first skeleton to depict the second subject performing the first signed word in the first sign language video. However, because the first skeleton and the second skeleton may be constructed based on different subjects, the second subject in the first sign language video may still appear to be different than the second subject in the second sign language video despite the details of the second subject being used in conjunction with the first skeleton. For example, the second subject may be depicted in the first sign language video, but may have the size, shape, proportions, and/or dimensions of the first subject. As a result, the subject depicted in a combined sign language video may appear to change from being short to tall, tall to short, small to large, large to small, and/or other changes that may occur due to different skeletons being used to generate the combined sign language video. Consequently, the operational workflow 700 may be used to modify an image such that the object depicted in the image may be depicted consistently with a different object in a different image.

The set of reference points 705 may correspond to an object in the image. For example, the set of reference points 705 may correspond to a subject (e.g., the subject 202 of FIGS. 2A and 2B), an item, background, foreground, a prop, or any other object that may be obtained from an image. For instance, as illustrated in FIG. 8A, a set of reference points 810 may correspond to the object 802 in the image 830.

The object may have a first portion and a second portion. For example, as illustrated in FIG. 8A, the object 802 in the image 830 may be a person, a first portion 804 of the object 802 may include a body of the person, and a second portion 806 of the object 802 may include a head of the person.

In some embodiments, each portion of the object, such as each body part of a person when the person is an object, may have a corresponding reference point in the set of reference points 705. For instance, the head may have corresponding reference points in the set of reference points 705 indicating the position of the various features, e.g. eyes, ears, a nose, a mouth, the forehead, the cheeks, the chin, and/or other features of the head in the image, and the body may have corresponding reference points in the set of reference points 705 indicating the position of various body parts, e.g., a torso, legs, a neck, shoulders, elbows, wrists, hands, fingers, in the image.

In some embodiments, a first measurement 710 may be determined using the set of reference points 705. In some embodiments, the first measurement 710 may be a measurement of the first portion of the object. The first measurement 710 may be a distance between two or more reference points in the set of reference points 705.

In some embodiments, the distance determined may be a Euclidian distance. For example, the first measurement 710 may be determined using the X-coordinate and Y-coordinate of a first reference point and the X-coordinate and Y-coordinate of a second reference point.

For example, as illustrated in FIG. 8A, a first measurement 808 may be determined using the set of reference points 810. In some embodiments, the first measurement 808 may be determined between a first reference point 810a that corresponds to the first portion 804 and a second reference point 810b that corresponds to the first portion 804. For example, the first measurement 808 may be determined using the X-coordinate and the Y-coordinate of the first reference point 810a which may correspond to a first shoulder and the X-coordinate and the Y-coordinate of the second reference point 810b which may correspond to a second shoulder. Thus, the first measurement 808 may be determined between the first shoulder of the object 802 and the second shoulder of the object 802 such that the first measurement 808 represents a shoulder-to-shoulder distance. As illustrated in FIG. 8A, the set of reference points 810 may include additional reference points corresponding to the first portion 804 and/or the second portion 806 other than those specifically described with reference to FIG. 8A.

In some embodiments, the first measurement 710 may be obtained by mathematically combining, such as by a mean, median, weighted mean, or other mathematical combination, the distance between the first reference point and the second reference point over multiple images of the object. For example, the first measurement 710 may be obtained by averaging the distance between the first reference point and the second reference point in each frame of a video from which the images are the individual frames of the video.

Based on the first measurement 710, a first normalization factor 715 may be determined. In some embodiments, the first normalization factor 715 may be determined by comparing the first measurement 710 to a first standard measurement for the first measurement 710.

The first standard measurement may be based on two or more standard reference points that may correspond to a reference object in a reference image. The standard reference points may correspond to a subject (e.g., the subject 202 of FIGS. 2A and 2B), an item, background, foreground, a prop, or any other object. The standard reference points may be obtained in a similar manner as the set of reference points 705.

In some embodiments, the reference object in the reference image may represent the visual standard for how objects that are the same as the reference object and/or objects that are to be modified to be the same as the reference object may be depicted in an image. For example, the reference object may have the desired proportions, dimensions, size, shape, and/or other features for objects matching or that are to be modified to match the reference object. For instance, the reference object may be a particular avatar such as a wizard that is sized, shaped, proportioned, and/or dimensioned such that the wizard may be depicted as desired.

In these and other embodiments, the desired features may be defined by the standard reference points. Thus, standard measurements may be obtained between two or more standard reference points that may be compared against measurements (e.g., the first measurement 710) from the object in the image to determine whether the object may be depicted consistently with the reference image. As a result, the reference object in the reference image may serve as a guide to ensure that objects that are the same as the reference object and/or are to be modified to be the same as the reference object may be depicted appropriately.

In some embodiments, the reference object depicted in the reference image may be the same object depicted in the image from which the set of reference points 705 may be obtained, but the reference object may have a different dimensions than the object depicted in the image. For example, the reference object may be a male human subject, and the object 802 may be the same male human subject but with different dimensions (e.g., as a result of image parameter differences). In some embodiments, the reference object depicted in the reference image may be different than the object depicted in the image. For example, the reference object may be a female human subject, and the object 802 may be a male human subject.

In these and other embodiments, a reference image may be stored for different objects. For example, as discussed previously, a reference image may be stored in the data storage 150 illustrated in FIG. 1 for each potential subject (e.g., avatar) that may be used in the combined sign language video that may be generated by the communication system 130. In these and other embodiments, the reference images may be associated with corresponding sign language videos in the data storage 150. For example, a reference image of a male subject may be associated with corresponding sign language videos in the data storage 150 that may depict the male subject performing one or more signed words. In some embodiments, the reference images may not be stored in the data storage 150. In these and other embodiments, the reference images may be provided to an AI model (e.g., a GAN) such that the combined sign language video may be generated based on the sign language videos, the transition videos, and the reference images.

Returning to FIG. 7, the first standard measurement may be determined in a similar manner as the first measurement 710, but using the standard reference points corresponding to the reference object in the reference image. In some embodiments, the first standard measurement may be determined using two or more standard reference points that correspond to a similar location on the reference object that the first and second reference points correspond to on the object in the image.

For example, the first standard measurement may be determined using a first standard reference point that corresponds to a first portion (e.g., a first shoulder) of the reference object and a second standard reference point that corresponds to the first portion (e.g., a first shoulder) of the reference object. Thus, the first standard measurement may be a standard shoulder-to-shoulder distance, which the first measurement 808 illustrated in FIG. 8A may be compared against.

Comparing the first measurement 710 to a first standard measurement may include performing a mathematical calculation using the first measurement 710 and the first standard measurement to generate the first normalization factor 715. For example, in some embodiments, the first normalization factor 715 may be a ratio of the first measurement 710 and the first standard measurement. As a result, in some embodiments, the first measurement 710 may be less than the first standard measurement, and the first normalization factor 715 may be greater than one. In some embodiments, the first measurement 710 may be greater than the first standard measurement, and the first normalization factor 715 may be less than one.

For example, the first measurement 808 illustrated in FIG. 8A may be compared to the first standard measurement to determine the first normalization factor 715. For instance, the first measurement 808 may measure the shoulder-to-shoulder distance, the first standard measurement may be a standard shoulder-to-shoulder distance measured in a reference image for the object 802 or a different object, and the first measurement 808 may be compared against the standard shoulder-to-shoulder distance to determine the first normalization factor 715.

In some embodiments, one or more reference points in the set of reference points 705 may be modified by the first normalization factor 715 to generate a first modified set of reference points 720. In some embodiments, modification of the set of reference points 705 may be achieved by multiplying coordinates of the one or more reference points in the set of reference points 705 by the first normalization factor 715.

For example, the set of reference points 810 illustrated in FIG. 8A may be modified by the first normalization factor 715 to generate a modified set of reference points 812. As a result of generating the modified set of reference points 812, a modified image 840 including the object 802 may be generated based on the modified set of reference points 812. For example, the first portion 804 of the object 802 may be generated based on the modified reference points that correspond to the first portion 804 and/or the second portion 806 of the object 802 may be generated based on the modified reference points that correspond to the second portion 806. Thus, the first portion 804 and/or the second portion 806 may appear to be different in the modified image 840 compared to the image 830.

In some embodiments, the first normalization factor 715 may be greater than one, and the image may be modified such that at least a portion of the object appears to be larger in the image. For example, modifying the set of reference points 705 with a first normalization factor 715 that is greater than one may cause the absolute value of the coordinates of the reference points (e.g., X-coordinate, Y coordinate, and/or Z-coordinate) to increase. For instance, the coordinates of the reference points corresponding to the object may be spread apart, which may cause the object to appear larger in the image. For example, as illustrated in FIG. 8A, the modified set of reference points 812 may result in the object 802 appearing to be larger in the modified image 840 than the object 802 in the image 830.

In some embodiments, the first normalization factor 715 may be less than one, and the image may be modified such that at least a portion of the object appears to be smaller in the image. For example, modifying the set of reference points 705 with a first normalization factor 715 that is less than one may cause the absolute value of the coordinates of the reference points (e.g., X-coordinate, Y coordinate, and/or Z-coordinate) to decrease. For instance, the coordinates of the reference points corresponding to the object may be moved closer together, which may cause the object to appear smaller in the image.

In some embodiments, the first normalization factor 715 may be applied to each reference point in the set of reference points 705 to generate the first modified set of reference points 720. In some embodiments, the first normalization factor 715 may be applied to the reference points corresponding to the first portion and not to the reference points corresponding to the second portion in the set of reference points 705 to generate the first modified set of reference points 720. In some embodiments, the first normalization factor 715 may be applied to one or more reference points in the set of reference points 705 that correspond to the first portion and/or one or more reference points in the set of reference points 705 that correspond to the second portion to generate the first modified set of reference points 720.

As illustrated in FIG. 8B, the modified set of reference points 812 may include modified reference points that correspond to the first portion 804 and/or the second portion 806. The modified set of reference points 812 may have a first modified reference point 812a that may correspond to a first ear, a second modified reference point 812b that may correspond to a second ear, a third modified reference point 812c that may correspond to a base of the head, a fourth modified reference point 812d that may correspond to a top of the head, a fifth modified reference point 812e that may correspond to the nose, and/or a sixth modified reference point 812f that may correspond to the neck. As illustrated in FIG. 8B, the modified set of reference points 812 may include additional reference points corresponding to the first portion 804 and/or the second portion 806 other than those specifically described with reference to FIG. 8B.

In some embodiments, after the reference points in the set of reference points 705 have been modified, a second measurement 725 of the object may be determined using the first modified set of reference points 720. In some embodiments, the second measurement 725 may correspond to the second portion of the object. The second measurement 725 may be a distance between two or more modified reference points in the first modified set of reference points 720.

In some embodiments, the distance determined may be a Euclidian distance. In some embodiments, the second measurement 725 may be determined using the X-coordinate of a first modified reference point and the X-coordinate of a second modified reference point in the first modified set of reference points 720.

For example, as illustrated in FIG. 8B, a second measurement 814 may be determined using the modified set of reference points 812 from the modified image 840. In some embodiments, the second measurement 814 may be determined between the first modified reference point 812a that corresponds to the second portion 806 and the second modified reference point 812b that corresponds to the second portion 806. In some embodiments, the object 802 may be a person, the first modified reference point 812a may correspond to the body or the head of the person, and the second modified reference point 812b may correspond to the same portion as the first modified reference point. For example, the second measurement 814 may be determined using the X-coordinate of the first modified reference point 812a which may correspond to a first ear and the X-coordinate of the second modified reference point 812b which may correspond to a second ear. Thus, the second measurement 814 may be determined between a first ear and a second ear such that the second measurement 814 represents an ear-to-ear distance.

In some embodiments, the second measurement 725 may be obtained by mathematically combining, such as by a mean, median, weighted mean, or other mathematical combination, the distance between the first modified reference point and the second modified reference point over multiple images of the object. For example, the first measurement 710 may be obtained by averaging the distance between the first modified reference point and the second modified reference point in each frame of a video from which the images are the individual frames of the video.

Based on the second measurement 725, a second normalization factor 730 may be determined. In some embodiments, the second normalization factor 730 may be determined by comparing the second measurement 725 to a second standard measurement for the second measurement 725. The second normalization factor 730 may be generated in a similar manner as the first normalization factor 715.

In these and other embodiments, the second standard measurement may be based on two or more standard reference points in the reference image similar to the first standard measurement. In some embodiments, the second standard measurement may be determined using two or more standard reference points that correspond to a similar location on the reference object that the first and second modified reference points in the first modified set of reference points 720 correspond to on the object in the image.

For example, the second measurement 814 illustrated in FIG. 8B may be compared to the second standard measurement to determine the second normalization factor 730. For instance, the second measurement 814 may measure the ear-to-ear distance, the second standard measurement may be a standard ear-to-ear distance measured using a reference image for the object 802 or a different object, and the second measurement 814 may be compared against the standard ear-to-ear distance to determine the second normalization factor 730.

In some embodiments, one or more modified reference points in the first modified set of reference points 720 may be modified by the second normalization factor 730 to generate a second modified set of reference points 735. In some embodiments, the one or more modified reference points in the first modified set of reference points 720 that may be modified by the second normalization factor 730 may correspond to the second portion of the object. In some embodiments, modification of the one or more modified reference points in the first modified set of reference points 720 may be achieved by multiplying the coordinates of the one or more modified reference points by the second normalization factor 730.

For example, one or more modified reference points in the modified set of reference points 812 illustrated in FIG. 8B may be modified by the second normalization factor 730 to generate a remodified set of reference points 816. For instance, the second normalization factor 730 may be applied to the first through the fifth modified reference points 812a-812e and/or any other modified reference points that may correspond to the second portion 806 to generate a first remodified reference point 816a, a second remodified reference point 816b, a third remodified reference point 816c, a fourth remodified reference point 816d, and a fifth remodified reference point 816e, and/or other remodified reference points that correspond to the second portion 806. Thus, in some embodiments, the second normalization factor 730 may not be applied to the sixth modified reference point 812f and/or other modified reference points in the modified set of reference points 812 that correspond to the first portion 804.

As illustrated in FIG. 8B, a remodified image 850 may be generated based on the modified set of reference points 812 and the remodified set of reference points 816. For example, the first portion 804 of the object 802 may be generated based on the modified reference points in the modified set of reference points 812 that correspond to the first portion 804, and the second portion 806 of the object 802 may be generated based on the remodified reference points in the remodified set of reference points 816 that correspond to the second portion 806. Thus, the first portion 804 may appear to be the same between the modified image 840 and the remodified image 850, but the second portion 806 may appear to be different in the remodified image 850 compared to the modified image 840.

In some embodiments, the second normalization factor 730 may be greater than one, and the image may be modified such that at least a portion of the object appears to be larger in the image as described with respect to the first normalization factor 715.

In some embodiments, the second normalization factor 730 may be less than one, and the image may be modified such that at least a portion of the object appears to be smaller in the image as described with respect to the first normalization factor 715.

In some embodiments and as described above, the second normalization factor 730 may be applied to the one or more modified reference points in the first modified set of reference points 720 that correspond to the second portion to generate the second modified set of reference points 735. In some embodiments, the second normalization factor 730 may be applied to each of the modified reference points in the first modified set of reference points 720 to generate the second modified set of reference points 735. In some embodiments, the second normalization factor 730 may be applied to one or more modified reference points in the first modified set of reference points 720 that correspond to the first portion to generate the second modified set of reference points 735.

As illustrated in FIG. 8C, the remodified image 850 may include the modified reference points in the modified set of reference points 812 that correspond to the first portion 804 and the remodified set of reference points 816 that may correspond to the second portion 806. For example, the remodified image 850 may include the sixth modified reference point 812f, which may correspond to the neck, and/or any other modified reference points that may correspond to the first portion 804, and the remodified image 850 may include the fifth remodified reference point 816e, which may correspond to the nose, and/or any other remodified reference points that may correspond to the second portion 806. As illustrated in FIG. 8C, the modified set of reference points 812 may include additional reference points corresponding to the first portion 804 and the remodified set of reference points 816 may include additional reference points corresponding to the second portion 806 other than those specifically described with reference to FIG. 8C.

In some embodiments, a third measurement 740 of the object may be determined using the first modified set of reference points 720 and/or the second modified set of reference points 735. In some embodiments, the third measurement 740 may be a distance between the first portion and the second portion of the object. For example, the third measurement 740 may be a distance between a modified reference point in the first modified set of reference points 720 that corresponds to the first portion, and a second modified reference point in the second modified set of reference points 735 that corresponds to the second portion. For instance, where the object is a person, the first modified reference point in the first modified set of reference points 720 may correspond to the body or the head of the person, and the second reference point in the second modified set of reference points 735 may correspond to a different portion of the person.

As described previously, in some embodiments, the first normalization factor 715 may be applied to each reference point in the set of reference points 705 to generate the first modified set of reference points 720, and the second normalization factor 730 may be applied to each modified reference point in the modified set of reference points 720 that correspond to the second portion to generate the second modified set of reference points 735. In some embodiments, the third measurement 740 may be determined after application of the first normalization factor 715 and the second normalization factor 730, and the reference points in the set of reference points 705 corresponding to the second portion may be modified twice (e.g., by the first normalization factor 715 and the second normalization factor 730). In these and other embodiments, the reference points in the set of reference points 705 corresponding to the first portion may have been modified once (e.g., via application of the first normalization factor 715) when the third measurement 740 is determined.

In some embodiments, the distance determined by the third measurement 740 may be a Euclidian distance. In some embodiments, the third measurement 740 may be determined using the Y-coordinate of the first modified reference point in the first modified set of reference points 720 and using the Y-coordinate of the second modified reference point in the second modified set of reference points 735.

For example, as illustrated in FIG. 8C, a third measurement 818 may be determined using the remodified set of reference points 816 and/or the modified set of reference points 812 from the remodified image 850. In some embodiments, the third measurement 818 may be determined between a modified reference point that corresponds to the first portion 804 and a remodified reference point that corresponds to the second portion 806. For example, the third measurement 818 may be determined using the Y-coordinate of the sixth modified reference point 812f which may correspond to the neck of the object 802 and the Y-coordinate of the fifth remodified reference point 816e which may correspond to the nose of the object 802. Thus, the third measurement 818 may be determined between the neck and the nose of the object 802 such that the third measurement 818 represents a nose-to-neck distance.

In some embodiments, the third measurement 740 may be obtained by mathematically combining, such as by a mean, median, weighted mean, or other mathematical combination, the distance between the first modified reference point in the first modified set of reference points 720 and the second modified reference point in the second modified set of reference points 735 over multiple images of the object. For example, the third measurement 740 may be obtained by averaging the distance between the first modified reference point and the second modified reference point in each frame of a video from which the images are the individual frames of the video.

Based on the third measurement 740, a third normalization factor 745 may be determined. In some embodiments, the third normalization factor 745 may be determined by comparing the third measurement 740 to a third standard measurement for the third measurement 740. The third normalization factor 745 may be generated in a similar manner as the first normalization factor 715 and the second normalization factor 730.

In these and other embodiments, the third standard measurement may be based on two or more standard reference points in the reference image similar to the first and the second standard measurements. In some embodiments, the third standard measurement may be determined using two or more standard reference points that correspond to a similar location on the reference object that the first modified reference point in the first modified set of reference points 720 and the second modified reference point in the second modified set of reference points 735 correspond to on the object in the image.

For example, the third measurement 818 illustrated in FIG. 8C may be compared to the third standard measurement to determine the third normalization factor 745. For instance, the third measurement 818 may measure the nose-to-neck distance, the third standard measurement may be a standard nose-to-neck distance measured using a reference image for the object 802 or a different object, and the third measurement 818 may be compared against the standard nose-to-neck distance to determine the third normalization factor 745.

In some embodiments, one or more modified reference points in the first modified set of reference points 720 and/or one or more modified reference points in the second modified set of reference points 735 may be modified by the third normalization factor 745 to generate a third modified set of reference points 750. In some embodiments, the one or more modified reference points in the first modified set of reference points 720 that may be modified by the third normalization factor 745 may correspond to the first portion of the object and the one or more modified reference points in the second modified set of reference points 735 may correspond to the second portion of the object.

For example, as illustrated in FIG. 8C, the one or more modified reference points in the modified set of reference points 812 that correspond to the first portion 804 and the one or more remodified reference points in the remodified set of reference points 816 that may correspond to the second portion 806 may be modified by the third normalization factor 745 to generate a normalized set of reference points 820. In some embodiments, the third normalization factor 745 may be applied to each of the modified reference points in the modified set of reference points 812 that correspond to the first portion 804 and each of the remodified reference points in the remodified set of reference points 812 that correspond to the second portion 806 to generate the normalized set of reference points 820.

As a result, a normalized image 860 may be generated based on the normalized set of reference points 820. For example, the first portion 804 of the object 802 may be generated based on the normalized reference points that correspond to the first portion 804, and the second portion 806 of the object 802 may be generated based on the normalized reference points that correspond to the second portion 806. Thus, the first portion 804 and/or the second portion 806 may appear to be different in the normalized image 860 compared to the remodified image 850.

In some embodiments, modification of the first modified set of reference points 720 and/or the second modified set of reference points 735 may be achieved by multiplying the coordinates of the one or more modified reference points in the first modified set of reference points 720 and/or the coordinates of the one or more modified reference points in the second modified set of reference points 735 by the third normalization factor 745. For example, the Y-coordinates of the modified reference points corresponding to the first and/or second portions of the object may be adjusted by applying the third normalization factor 745.

In some embodiments, the third normalization factor 745 may be greater than one, and the image may be modified such that at least a portion of the object appears to be larger in the image as described with respect to the first normalization factor 715.

In some embodiments, the third normalization factor 745 may be less than one, and the image may be modified such that at least a portion of the object appears to be smaller in the image as described with respect to the first normalization factor 715.

In some embodiments and as described above, the third normalization factor 745 may be applied to the one or more modified reference points in the first modified set of reference points 720 which correspond to the first portion and/or the one or more modified reference points in the second modified set of reference points 735 which correspond to the second portion to generate the third modified set of reference points 750.

The third modified set of reference points 750 may include modified reference points corresponding to the object that have been modified one time (e.g., via the first normalization factor 715, the second normalization factor 730, or the third normalization factor 745), two times (e.g., via the first normalization factor 715, the second normalization factor 730, and/or the third normalization factor 745), three times (e.g., via the first normalization factor 715, the second normalization factor 730, and the third normalization factor 745), and/or a higher number of times depending on whether other measurements and normalization factors are utilized.

The modification of the set of reference points 705 in the operational workflow 700 may help to enable the object in an image such as a frame obtained from a video to be depicted in the image in a consistent manner compared to how the object is depicted in other images such as other frames from the video and/or other frames from other videos. Thus, the image may be combined with other images with less distortion, perceptual differences, and/or scale differences of the object in the image. Furthermore, the image may be modified such that the object in the image is depicted consistently with other objects in other images that may be different than the original object.

For example, the normalized image 860 may be combined with another image such as another frame of a video such as a sign language video and/or a transition video. Combining the normalized image 860 with another image instead of using the image 830 unmodified may reduce the number and/or severity of rendering artifacts and/or may allow the object 802 to appear to be consistently scaled, sized, and/or proportioned between the combination of images.

Modifications, additions, or omissions may be made to the operational workflow 700 and/or the example implementation 800 without departing from the scope of the disclosure. For example, in some embodiments, the first measurement 710 and the first normalization factor 715 may be omitted. In some embodiments, the second measurement 725 and the second normalization factor 730 may be omitted. In some embodiments, the third measurement 740 and the third normalization factor 745 may be omitted.

Furthermore, in some embodiments, the third measurement 740 may be determined after application of the first normalization factor 715 but before the second measurement 725 is determined. In these and other embodiments, the third normalization factor 745 may only be applied to one or more modified reference points in the first modified set of reference points 720.

Additionally, in some embodiments, the first measurement 710, the second measurement 725, and/or the third measurement 740 may be determined in a different sequence than the sequence described with respect to FIG. 7. In some embodiments, the first normalization factor 715, the second normalization factor 730, and/or the third normalization factor 745 may be determined and/or applied in a different sequence than the sequence described with described with respect to FIG. 7.

Furthermore, in some embodiments, the measurements may correspond to multiple portions of the object and/or different portions of the object than described with reference to the operational workflow 700 and the example implementation 800.

In some embodiments, the object may include additional portions. For example, the object 802 of FIG. 8A-8C may include a third portion and/or a fourth portion. In some embodiments, the first portion or the second portion may be omitted and the measurements may be determined based on a single portion.

In some embodiments, additional measurements may be determined and/or additional normalization factors may be determined and applied based on the additional measurements. For example, a fourth measurement of the object may be determined and a fourth normalization factor may be determined and applied to the object based on the fourth measurement.

Furthermore, while the normalized image 860 and the normalized set of reference points 820 are described as “normalized,” some of the measurements and the normalization factors may be omitted as discussed above such that the modified image 840 and the modified set of reference points 812 and/or the remodified image 850 and the remodified set of reference points 816 described with respect to FIG. 8A-8C may also be considered normalized.

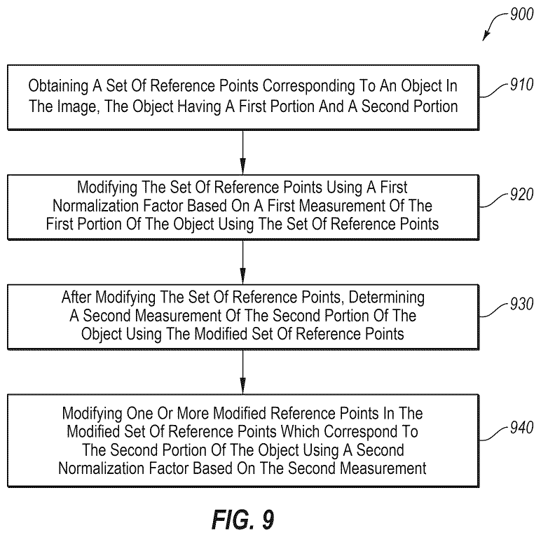

FIG. 9 illustrates a flowchart of an example method 900 of normalizing reference points in an image, in accordance with one or more embodiments of the present disclosure. The method 900 may be performed by any suitable system, apparatus, or device. For example, the method 900 may be implemented using the environment 100 of FIG. 1 or the computing system 1000 of FIG. 10. The method 900 may be implemented as part of the operational workflow 700 described with respect to FIG. 7 and/or the example implementation 800 described with respect to FIGS. 8A, 8B, and 8C. Although illustrated with discrete blocks, the steps and operations associated with one or more blocks of the method 900 may be divided into additional blocks, combined into fewer blocks, or eliminated, depending on the particular implementation.

The method 900 of normalizing reference points in an image may include blocks 910, 920, 930, and 940. At block 910, a set of reference points may be obtained that correspond to an object in the image. In some embodiments, the object may have a first portion and a second portion. In some embodiments, the object in the image may be a person, the first portion may be the body of the person, and the second portion may be the head of the person.

At block 920, the set of reference points may be modified using a first normalization factor based on a first measurement of the first portion of the object using the set of reference points. In some embodiments, modifying the set of reference points may result in a modification of the image. In some embodiments, modifying the set of reference points may include altering coordinates of the reference points in the set of reference points, and the coordinates may provide a position of the reference points in the image.

At block 930, after modifying the set of reference points, a second measurement of the second portion of the object may be determined using the modified set of reference points.

At block 940, one or more modified reference points in the modified set of reference points which correspond to the second portion of the object may be modified using a second normalization factor based on the second measurement.

Modifications, additions, or omissions may be made to the method 900 without departing from the scope of the disclosure. For example, the designations of different elements in the manner described is meant to help explain concepts described herein and is not limiting. Further, the method 900 may include any number of other elements or may be implemented within other systems or contexts than those described.

In some embodiments, the method 900 may further include modifying the image by adjusting the first portion and the second portion of the object based on the modified set of reference points.

In some embodiments, after modifying the set of reference points, a third measurement between the first portion of the object and the second portion of the object may be determined using the modified set of reference points.

In these and other embodiments, the modified set of reference points may be modified using a third normalization factor based on the third measurement. In some embodiments, the third measurement may be determined after modifying the set of reference points and after modifying the one or more modified reference points which correspond to the second portion of the object.

In some embodiments, the one or more modified reference points in the modified set of reference points that correspond to one of the first portion or the second portion may be modified using the third normalization factor based on the third measurement.

In some embodiments, the first measurement may be a distance between two reference points in the set of reference points that correspond to the body. In some embodiments, the second measurement may be a distance between two reference points in the modified set of reference points that correspond to the head. In some embodiments, the third measurement may be a distance between a first modified reference point that corresponds to the body and a second modified reference point that corresponds to the head.

In some embodiments, a first standard measurement may be determined using a set of standard reference points corresponding to a reference object in a reference image. In these and other embodiments, the first standard measurement may be compared to the first measurement to determine the first normalization factor.

In some embodiments, a second standard measurement may be determined using the set of standard reference points. In these and other embodiments, the second standard measurement may be compared to the second measurement to determine the second normalization factor. In these and other embodiments, the reference object in the reference image may be a different object than the object in the image.

FIG. 10 illustrates an example system 1000 that may be used during sign language generation, interpolation of motion, and/or normalization of reference points in an image. The system 1000 may be arranged in accordance with at least one embodiment described in the present disclosure. The system 1000 may include a processor 1010, memory 1020, a communication unit 1030, a display 1040, a user interface unit 1050, and a peripheral device 1060, which all may be communicatively coupled. In some embodiments, the system 1000 may be part of any of the systems or devices described in this disclosure.

For example, the system 1000 may be configured to perform the functions and/or tasks of the systems and/or devices described in the environments disclosed in this disclosure. For example, each of the systems and/or devices described in the environments disclosed in this disclosure may include one or more of the elements of the system 1000.

Generally, the processor 1010 may include any suitable special-purpose or general-purpose computer, computing entity, or processing device including various computer hardware or software modules and may be configured to execute instructions stored on any applicable computer-readable storage media. For example, the processor 1010 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 10, it is understood that the processor 1010 may include any number of processors distributed across any number of networks or physical locations that are configured to perform individually or collectively any number of operations described herein. In some embodiments, the processor 1010 may interpret and/or execute program instructions and/or process data stored in the memory 1020. In some embodiments, the processor 1010 may execute the program instructions stored in the memory 1020.

For example, in some embodiments, the processor 1010 may execute program instructions stored in the memory 1020 that are related to sign language generation, normalization, and/or interpolation such that the system 1000 may perform or direct the performance of the operations associated therewith as directed by the instructions. In these and other embodiments, the instructions may be used to perform one or more operations of the methods, operational workflows, and/or processes described in this disclosure.

The memory 1020 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 1010.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 1010 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 700 F. 3d 1346 (Fed. Cir. 2007). Combinations of the above may also be included within the scope of computer-readable media.

The communication unit 1030 may include any component, device, system, or combination thereof that is configured to transmit or receive information over a network. In some embodiments, the communication unit 1030 may communicate with other devices at other locations, the same location, or even other components within the same system. For example, the communication unit 1030 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 1030 may permit data to be exchanged with a network and/or any other devices or systems described in the present disclosure.

The display 1040 may be configured as one or more displays, like an LCD, LED, Braille terminal, or other type of display. The display 1040 may be configured to present video, text captions, user interfaces, and other data as directed by the processor 1010.

The user interface unit 1050 may include any device to allow a user to interface with the system 1000. For example, the user interface unit 1050 may include a mouse, a track pad, a keyboard, buttons, camera, and/or a touchscreen, among other devices. The user interface unit 1050 may receive input from a user and provide the input to the processor 1010. In some embodiments, the user interface unit 1050 and the display 1040 may be combined.

The peripheral devices 1060 may include one or more devices. For example, the peripheral devices 1060 may include a microphone, an imager, and/or a speaker, among other peripheral devices 1060. In these and other embodiments, the microphone may be configured to capture audio. The imager may be configured to capture images. The images may be captured in a manner to produce video or image data. In some embodiments, the speaker may broadcast audio received by the system 1000 or otherwise generated by the system 1000.

Modifications, additions, or omissions may be made to the system 1000 without departing from the scope of the present disclosure. For example, in some embodiments, the system 1000 may include any number of other components that may not be explicitly illustrated or described. Further, depending on certain implementations, the system 1000 may not include one or more of the components illustrated and described.

An example of how the embodiments described in this disclosure may be combined is now provided. In some embodiments, the communication system 130 may obtain and/or generate the first sign language video 200, the second sign language video 220, and/or the transition video 240 to generate the combined sign language video 260 of FIGS. 2A and 2B. In some embodiments, the communication system 130 may perform any one of methods, operational workflows, or processes illustrated in FIGS. 3-9.

Thus, the concepts discussed with respect to FIG. 1-10 illustrate concepts that may be implemented in a variety of ways, devices, and systems all with respect to generating sign language, interpolating between images, and/or normalizing images. Thus, concepts from any one of the figures may be implemented with respect to any of the figures.

The subject technology of the present disclosure is illustrated, for example, according to various aspects described below. Various examples of aspects of the subject technology are described as numbered examples (1, 2, 3, etc.) and sub examples (1.1, 1.2, 1.3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example. As another example, one or more aspects of sub example 1.1 below may be omitted, substituted for one or more aspects of another sub example (e.g., example 1.2) or examples, or combined with aspects of another example. The following is a non-limiting summary of some example implementations presented herein.

Example 1.1 may include a method comprising:
obtaining a first set of reference points corresponding to an object in a first position, the object including a first portion and a second portion connected to the first portion, each portion having a corresponding reference point in the first set of reference points;
obtaining a second set of reference points corresponding to the object in a second position, each portion of the object having a corresponding reference point in the second set of reference points;
generating, based on a first interpolation algorithm, a first interpolated reference point for the first portion based on a first movement vector that defines a movement of the first portion between the first set of reference points and the second set of reference points; and
generating, based on a second interpolation algorithm that is different than the first interpolation algorithm, a second interpolated reference point for the second portion based on the first interpolated reference point and a second movement vector that defines a movement of the second portion between the first set of reference points and the second set of reference points, the second movement vector determined using the first movement vector.

Example 1.2: The method of Example 1.1 further comprising creating a set of interpolated reference points including the first interpolated reference point and the second interpolated reference point, the set of interpolated reference points corresponding to the object in a third position that is between the first position and the second position.

Example 1.3: The method of Example 1.1, wherein the object further includes a third portion, and the third portion has a corresponding reference point in the first set of reference points and the second set of reference points, wherein the method further comprises:
generating, based on a third interpolation algorithm that is different than the second interpolation algorithm, a third interpolated reference point for the third portion based on the second interpolated reference point and a third movement vector that defines a movement of the third portion between the first set of reference points and the second set of reference points, the third movement vector determined using the second movement vector.

Example 1.4: The method of Example 1.3, further comprising creating a set of interpolated reference points including the first interpolated reference point, the second interpolated reference point, and the third interpolated reference point, the set of interpolated reference points corresponding to the object in a third position that is between the first position and the second position.

Example 1.5: The method of Example 1.3, wherein the object includes a body, the first portion includes a wrist, the second portion includes a hand, and the third portion includes a finger.

Example 1.6: The method of Example 1.5, wherein the first position corresponds to at least a portion of a first signed word and the second position corresponds to at least a portion of a second signed word that is different than the first signed word.

Example 1.7: The method of Example 1.3, wherein the first interpolation algorithm utilizes forward kinematics to determine the first movement vector, the second interpolation algorithm utilizes parallel translation and rotation to determine the second movement vector, and the third interpolation algorithm utilizes forward kinematics to determine the third movement vector.

Example 1.8: The method of Example 1.1, further comprising:
determining, via the first interpolation algorithm, the first movement vector from the corresponding reference point of the first portion in the first set of reference points to the corresponding reference point of the first portion in the second set of reference points; and
determining, via the second interpolation algorithm, the second movement vector from the corresponding reference point of the second portion in the first set of reference points to the corresponding reference point of the second portion in the second set of reference points, the second movement vector based on the first movement vector.

Example 1.9: The method of Example 1.8, wherein the object further includes a third portion, and the third portion has a corresponding reference point in the first set of reference points and the second set of reference points, wherein the method further comprises:
determining, via a third interpolation algorithm that is different than the second interpolation algorithm, a third movement vector from the corresponding reference point of the third portion in the first set of reference points to the corresponding reference point of the third portion in the second set of reference points, the third movement vector based on the second movement vector; and
generating, based on the third interpolation algorithm, a third interpolated reference point for the third portion based on the second interpolated reference point and the third movement vector.

Example 1.10: The method of Example 1.1, wherein a first end of the first portion of the object is coupled to a second end of the second portion of the object and the second movement vector being determined using the first movement vector includes setting second movement vector values of the second movement vector for the second end of the second portion of the object to first movement vector values of the first movement vector for the first end of the first portion.

Example 1.11: One or more non-transitory computer-readable mediums configured to store instructions that, when executed, perform the methods of any of Examples 1.1-1.10.

Example 1.12: A device configured to perform the methods of any of the Examples 1.1-1.10, the device comprising:
one or more non-transitory computer-readable media configured to store instructions; and
a processor coupled to the computer-readable media and configured to execute the instructions to perform operations.

Example 2.1 may include a method comprising:
obtaining data including a first word and a second word at a system configured to generate, in real-time, a sign language video representing the first word and the second word;
selecting, from a data storage of the system, a first video depicting performance of a first signed word corresponding to the first word and a second video depicting performance of a second signed word corresponding to the second word;
in response to a transition video that depicts movement between the first signed word and the second signed word not being available in the data storage, generating an interpolated transition video using the first video and the second video, the interpolated transition video depicting the movement between the first signed word and the second signed word; and
generating the sign language video based on the first video, the second video, and the interpolated transition video.

Example 2.2: The method of Example 2.1, further comprising:
obtaining additional data including a third word and a fourth word at the system, the system being configured to generate, in real-time, a second sign language video representing the third word and the fourth word;
selecting, from the data storage, a third video depicting performance of a third signed word corresponding to the third word, and a fourth video depicting performance of a fourth signed word corresponding to the fourth word; and
obtaining, in response to a transition video that depicts movement between the third signed word and the fourth signed word being available in the data storage, the transition video; and
generating the second sign language video based on the third video, the fourth video, and the transition video.

Example 2.3: The method of Example 2.1, further comprising:
obtaining a first frame included in the first video, the first frame depicting a subject in a first position, the first position corresponding to at least a portion of the first signed word;
obtaining a second frame included in the second video, the second frame depicting the subject in a second position, the second position corresponding to at least a portion of the second signed word;
generating an interpolated transition frame, the interpolated transition frame corresponding to the subject in a third position that is between the first position and the second position; and
wherein the interpolated transition video is generated using the interpolated transition frame.

Example 2.4: The method of Example 2.3, wherein the first frame is one of the last three frames of the first video and the second frame is one of the first three frames of the second video.

Example 2.5: The method of Example 2.3, further comprising:
obtaining a first set of reference points corresponding to the subject in the first position;
obtaining a second set of reference points corresponding to the subject in the second position; and
creating a set of interpolated reference points corresponding to the subject in the third position, wherein the interpolated transition frame is generated based on the set of interpolated reference points.

Example 2.6: The method of Example 2.5, further comprising:
providing the set of interpolated reference points to a Generative Adversarial Network (GAN); and
wherein the GAN generates the interpolated transition frame in response to being provided the set of interpolated reference points.

Example 2.7: The method of Example 2.1, wherein a GAN generates the sign language video based on the first video, the second video, and the interpolated transition video.

Example 2.8: The method of Example 2.1, further comprising obtaining, at the system, audio during a communication session that includes a first device and a second device, the audio originating at the second device, wherein the data including the first word and the second word is obtained from the audio.

Example 2.9: The method of Example 2.8, further comprising providing the sign language video to the first device wherein the sign language video is provided to the first device in real-time as the audio is obtained by the system.

Example 2.10: The method of Example 2.8, further comprising selecting, automatically and independently by the system based on the audio, a second translation process instead of a first translation process to translate the audio during the communication session, the first translation process causing the system to generate, in real-time, the sign language video representing the first word and the second word.

Example 2.11: One or more non-transitory computer-readable mediums configured to store instructions that, when executed, perform the methods of any of Examples 2.1-2.10.

Example 2.12: A device configured to perform the methods of any of the Examples 2.1-2.10, the device comprising:
one or more non-transitory computer-readable media configured to store instructions; and
a processor coupled to the computer-readable media and configured to execute the instructions to perform operations.

Example 3.1 may include a method comprising:
obtaining a set of reference points corresponding to an object in an image, the object having a first portion and a second portion;
modifying the set of reference points using a first normalization factor based on a first measurement of the first portion of the object using the set of reference points;
after modifying the set of reference points, determining a second measurement of the second portion of the object using the modified set of reference points; and
modifying one or more modified reference points in the modified set of reference points which correspond to the second portion of the object using a second normalization factor based on the second measurement.

Example 3.2: The method of Example 3.1, wherein modifying the set of reference points results in a modification of the image.

Example 3.3: The method of Example 3.1, further comprising:
after modifying the set of reference points, determining a third measurement between the first portion of the object and the second portion of the object using the modified set of reference points; and
modifying the modified set of reference points using a third normalization factor based on the third measurement.

Example 3.4: The method of Example 3.3, wherein the third measurement is determined after modifying the set of reference points and after modifying the one or more modified reference points which correspond to the second portion of the object.

Example 3.5: The method of Example 3.1, wherein modifying the set of reference points includes altering coordinates of the reference points in the set of reference points, the coordinates providing a position of the reference points in the image.

Example 3.6: The method of Example 3.1, further comprising:
after modifying the set of reference points, determining a third measurement between the first portion of the object and the second portion of the object using the modified set of reference points; and
modifying the one or more modified reference points in the modified set of reference points corresponding to one of the first portion or the second portion using a third normalization factor based on the third measurement.

Example 3.7: The method of Example 3.1, wherein the object in the image is a person, the first portion is a body of the person, the second portion is a head of the person, the first measurement is a distance between two reference points in the set of reference points that correspond to the body and the second measurement is a distance between two reference points in the modified set of reference points that correspond to the head.

Example 3.8: The method of Example 3.3, wherein the object in the image is a person, the first portion is a body of the person, the second portion is a head of the person, and the third measurement is a distance between a first modified reference point that corresponds to the body and a second modified reference point that corresponds to the head.

Example 3.9: The method of Example 3.1, further comprising:
determining a first standard measurement using a set of standard reference points corresponding to a reference object in a reference image;
comparing the first standard measurement to the first measurement to determine the first normalization factor;
determining a second standard measurement using two or more standard reference points using the set of standard reference points; and
comparing the second standard measurement to the second measurement to determine the second normalization factor.

Example 3.10: The method of Example 3.9, wherein the reference object in the reference image is a different object than the object in the image.

Example 3.11: One or more non-transitory computer-readable mediums configured to store instructions that, when executed, perform the methods of any of Examples 3.1-3.10.

Example 3.12: A device configured to perform the methods of any of the Examples 3.1-3.10, the device comprising:
one or more non-transitory computer-readable media configured to store instructions; and
a processor coupled to the computer-readable media and configured to execute the instructions to perform operations.

As indicated above, the embodiments described herein may include the use of a special purpose or general-purpose computer (e.g., the processor 1010 of FIG. 10) including various computer hardware or software modules, as discussed in greater detail with reference to FIG. 10. Further, as indicated above, embodiments described herein may be implemented using computer-readable media (e.g., the memory 1020 of FIG. 10) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of normalizing reference points in an image, the method comprising:
obtaining a set of reference points corresponding to an object in an image, the object having a first portion and a second portion;
modifying the set of reference points using a first normalization factor based on a first measurement of the first portion of the object using the set of reference points;
after modifying the set of reference points, determining a second measurement of the second portion of the object using the modified set of reference points; and
modifying one or more modified reference points in the modified set of reference points which correspond to the second portion of the object using a second normalization factor based on the second measurement.

2. The method of claim 1, wherein modifying the set of reference points results in a modification of the image.

3. The method of claim 1, further comprising:
after modifying the set of reference points, determining a third measurement between the first portion of the object and the second portion of the object using the modified set of reference points; and
modifying the modified set of reference points using a third normalization factor based on the third measurement.

4. The method of claim 3, wherein the third measurement is determined after modifying the set of reference points and after modifying the one or more modified reference points which correspond to the second portion of the object.

5. The method of claim 1, wherein modifying the set of reference points includes altering coordinates of the reference points in the set of reference points, the coordinates providing a position of the reference points in the image.

6. The method of claim 1, further comprising:
after modifying the set of reference points, determining a third measurement between the first portion of the object and the second portion of the object using the modified set of reference points; and
modifying the one or more modified reference points in the modified set of reference points corresponding to one of the first portion or the second portion using a third normalization factor based on the third measurement.

7. The method of claim 1, wherein the object in the image is a person, the first portion is a body of the person, the second portion is a head of the person, the first measurement is a distance between two reference points in the set of reference points that correspond to the body and the second measurement is a distance between two reference points in the modified set of reference points that correspond to the head.

8. The method of claim 3, wherein the object in the image is a person, the first portion is a body of the person, the second portion is a head of the person, and the third measurement is a distance between a first modified reference point that corresponds to the body and a second modified reference point that corresponds to the head.

9. The method of claim 1, further comprising:
determining a first standard measurement using a set of standard reference points corresponding to a reference object in a reference image;
comparing the first standard measurement to the first measurement to determine the first normalization factor;
determining a second standard measurement using two or more standard reference points using the set of standard reference points; and
comparing the second standard measurement to the second measurement to determine the second normalization factor.

10. The method of claim 9, wherein the reference object in the reference image is a different object than the object in the image.

11. One or more non-transitory computer-readable mediums configured to store instructions that when executed perform the method of claim 1.

12. A device comprising:
one or more non-transitory computer-readable media configured to store instructions; and
a processor coupled to the computer-readable media and configured to execute the instructions to perform operations, the operations comprising:
obtaining a set of reference points corresponding to an object in an image, the object having a first portion and a second portion;
modifying the set of reference points using a first normalization factor based on a first measurement of the first portion of the object using the set of reference points;
after modifying the set of reference points, determining a second measurement of the second portion of the object using the modified set of reference points; and
modifying one or more modified reference points in the modified set of reference points which correspond to the second portion of the object using a second normalization factor based on the second measurement.

13. The device of claim 12, wherein modifying the set of reference points results in a modification of the image.

14. The device of claim 12, wherein the operations further comprise:
after modifying the set of reference points, determining a third measurement between the first portion of the object and the second portion of the object using the modified set of reference points; and
modifying the modified set of reference points using a third normalization factor based on the third measurement.

15. The device of claim 14, wherein the third measurement is determined after modifying the set of reference points and after modifying the one or more modified reference points which correspond to the second portion of the object.

16. The device of claim 12, wherein modifying the set of reference points includes altering coordinates of the reference points in the set of reference points, the coordinates providing a position of the reference points in the image.

17. The device of claim 12, wherein the operations further comprise:
after modifying the set of reference points, determining a third measurement between the first portion of the object and the second portion of the object using the modified set of reference points; and
modifying the one or more modified reference points in the modified set of reference points corresponding to one of the first portion or the second portion using a third normalization factor based on the third measurement.

18. The device of claim 12, wherein the object in the image is a person, the first portion is a body of the person, the second portion is a head of the person, the first measurement is a distance between two reference points in the set of reference points that correspond to the body and the second measurement is a distance between two reference points in the modified set of reference points that correspond to the head.

19. The device of claim 14, wherein the object in the image is a person, the first portion is a body of the person, the second portion is a head of the person, and the third measurement is a distance between a first modified reference point that corresponds to the body and a second modified reference point that corresponds to the head.

20. The device of claim 12, wherein the operations further comprise:
determining a first standard measurement using a set of standard reference points corresponding to a reference object in a reference image;
comparing the first standard measurement to the first measurement to determine the first normalization factor;
determining a second standard measurement using two or more standard reference points using the set of standard reference points; and
comparing the second standard measurement to the second measurement to determine the second normalization factor.
